(19) United States
(12) Patent Application Publication
(10) Pub. No.: US 2021/0071108 A1
(43) Pub. Date: Mar. 11, 2021

(54) CONCENTRATED SURFACTANT SYSTEMS FOR RINSE AID AND OTHER APPLICATIONS

(71) Applicants: ECOLAB USA INC., Saint Paul, MN (US); BASF SE, Ludwigshafen (DE)

(72) Inventors: JANEL MARIE KIEFFER, Saint Paul, MN (US); JAMES S. DAILEY, Grosse Ile, MI (US); THOMAS GESSNER, Ypsilanti, MI (US); DOMINIK LANZINGER, Ludwigshafen (DE); JUERGEN TROPSCH, Ludwigshafen (DE)

(21) Appl. No.: 16/948,144

(22) Filed: Sep. 4, 2020

Related U.S. Application Data
(60) Provisional application No. 62/896,709, filed on Sep. 6, 2019.

(51) Int. Cl. C11D 1/76; C11D 1/825

(52) U.S. Cl. CPC C11D 1/76; C11D 1/8255

(57) ABSTRACT

Surfactant systems and compositions incorporating the same are disclosed for use as cleaning compositions and rinse aid compositions. The solid surfactant systems are prilled, pastilled, flaked or granular solids and are incorporated into solid formulations at high concentrations for both improved performance and manufacturing benefits. The methods of using the solid compositions containing the surfactant systems for cleaning applications and rinse aid applications are also disclosed.

### CROSS-REFERENCE TO RELATED APPLICATION

This application claims priority under 35 U.S.C. § 119 to Provisional Application U.S. Ser. No. 62/896,709, filed on Sep. 6, 2019, which is herein incorporated by reference in its entirety including without limitation, the specification, claims, and abstract, as well as any figures, tables, or examples thereof.

### FIELD OF THE INVENTION

The invention relates to solid polymer surfactant systems and compositions incorporating the same that contain a higher concentration of surfactants in the solid composition for both improved performance and manufacturing benefits. The surfactant systems contain solid copolymer surfactants (also referred to as polymer surfactant complexes) that are prilled, pastilled or granular and beneficially do not introduce liquid into the compositions. The present invention further relates to methods of using the solid compositions containing the surfactant systems for cleaning applications and rinse aid applications on all types of wares, including plastics, with minimal use of defoamers in the solid formulations.

### BACKGROUND OF THE INVENTION

Solid cleaning compositions and solid rinse aid compositions are desired for various consumer and industrial applications. However, formulation and manufacturing of such solid compositions are limited by the amount of liquid that can be used in such a solid composition. There is a need for solidified surfactants for use in solid compositions that do not add significant amounts of liquid into a solid formulation. There is also an ongoing need for solidified surfactants that do not require melting to be used in solid formulations, which also contributes liquid content into a solid formulation.

In addition, solid compositions must contain sufficient concentrations of surfactants to provide cleaning and rinsing efficacy without introducing excessive foaming into the formulation. Foaming surfactant, including solid surfactants, requires formulations with liquid defoamer. Although liquid defoaming technologies are well-known it is undesirable to introduce such liquid content into solid formulations. Although a number of foaming and low-foaming surfactants are currently known and commercially available, each having certain advantages and disadvantages. There is an ongoing need for solid surfactants that do not introduce foaming into a cleaning or rinsing composition.

Accordingly, it is an objective of the claimed invention to develop efficient surfactant systems for cleaning applications and rinse aid applications.

A further object of the invention is to provide solid polymer surfactant systems for such cleaning and rinse aid applications that are in solid forms for incorporation into solid compositions, including surfactant systems that are in a prilled, pastilled, flaked or granular form.

A further object of the invention is to provide a synergistic combination of surfactants for use in the solid polymer surfactant systems and compositions containing the same.

A still further object of the invention is to provide solid polymer surfactant systems to formulate into solid compositions, wherein the solid polymer surfactant systems comprise polymer surfactant complexes, including for example those polymerized of monomers in the presence of the surfactant as a solvent.

Other objects, advantages and features of the present invention will become apparent from the following specification taken in conjunction with the accompanying drawings.

### BRIEF SUMMARY OF THE INVENTION

In an embodiment, the present invention relates to solid polymer surfactant systems, compositions employing the surfactant systems and methods of using the same.

In an aspect, a solid copolymer surfactant system comprises:
(1) a solid copolymer surfactant comprising:
   (i) at least one polymer P1) that comprises polymerized units of at least one monomer A) selected from the group consisting of α,β-ethylenically unsaturated carboxylic acids, salts of α,β-ethylenically unsaturated carboxylic acids, α,β-ethylenically unsaturated carboxylic acid anhydrides and mixtures thereof; and
   (ii) at least one nonionic surfactant of the general formula (I),

R₁-(A)ₓ-(B)_{y1}-(A)_{z}-(B)_{y2}—R₂ (I),
wherein
R₁ and R₂ independently denote H or linear or branched, substituted or unsubstituted C1-C22 alkyl,
A denotes CH₂—CH₂—O,
B denotes CH₂—CHR₃—O, wherein R₃ denotes H or linear or branched, unsubstituted C1-C10 alkyl,
x is an integer in the range from 0 to 35,
y₁ is an integer in the range from 0 to 60,
y₂ is an integer in the range from 0 to 35, and
z is an integer in the range from 0 to 35,
wherein the sum of x+y₁+z+y₂ is at least 1,
wherein the copolymer surfactant has a glass transition temperature (Tg) of at least 50° C. as determined by differential scanning calorimetry according to DIN EN ISO 11357-2, at a heating rate of 20 K/min; and
(2) at least one additional surfactant and/or polymer.

In another aspect, a solid cleaning and/or rinse aid composition comprises:
(1) a solid copolymer surfactant comprising:
   (i) at least one polymer P1) that comprises polymerized units of at least one monomer A) selected from the group consisting of α,β-ethylenically unsaturated carboxylic acids, salts of α,β-ethylenically unsaturated carboxylic acids, α,β-ethylenically unsaturated carboxylic acid anhydrides and mixtures thereof; and
   (ii) at least one nonionic surfactant of the general formula (I),

R₁-(A)ₓ-(B)_{y1}-(A)_{z}-(B)_{y2}—R₂ (I),
wherein
R₁ and R₂ independently denote H or linear or branched, substituted or unsubstituted C1-C22 alkyl,
A denotes CH₂—CH₂—O,
B denotes CH₂—CHR₃—O, wherein R₃ denotes H or linear or branched, unsubstituted C1-C10 alkyl,
x is an integer in the range from 0 to 35,
y₁ is an integer in the range from 0 to 60,
y₂ is an integer in the range from 0 to 35, and
z is an integer in the range from 0 to 35,
wherein the sum of x+y₁+z+y₂ is at least 1,
wherein the copolymer surfactant has a glass transition temperature (Tg) of at least 50° C. as determined by differential scanning calorimetry according to DIN EN ISO 11357-2, at a heating rate of 20 K/min; and
(2) at least one additional surfactant, polymer surfactant, and/or at least one additional functional ingredient.

In another aspect, a solid cleaning and/or rinse aid composition comprises:
(1) a solid copolymer surfactant comprising:
   (i) at least one polymer P1) that comprises polymerized units of at least one monomer A) selected from the group consisting of α,β-ethylenically unsaturated carboxylic acids, salts of α,β-ethylenically unsaturated carboxylic acids, α,β-ethylenically unsaturated carboxylic acid anhydrides and mixtures thereof; and
   (ii) at least one nonionic surfactant of the general formula (I),

R₁-(A)ₓ-(B)_{y1}-(A)_{z}-(B)_{y2}—R₂ (I),
wherein
R₁ and R₂ independently denote H or linear or branched, substituted or unsubstituted C1-C22 alkyl,
A denotes CH₂—CH₂—O,
B denotes CH₂—CHR₃—O, wherein R₃ denotes H or linear or branched, unsubstituted C1-C10 alkyl,
x is an integer in the range from 0 to 35,
y₁ is an integer in the range from 0 to 60,
y₂ is an integer in the range from 0 to 35, and
z is an integer in the range from 0 to 35,
wherein the sum of x+y₁+z+y₂ is at least 1,
wherein the copolymer surfactant has a glass transition temperature (Tg) of at least 50° C. as determined by differential scanning calorimetry according to DIN EN ISO 11357-2, at a heating rate of 20 K/min;
(2) at least one additional surfactant and/or polymer; and
(3) at least one additional functional ingredient.

In still another aspect, a method for cleaning and/or rinsing a surface comprises: providing a solid composition as described herein; contacting the solid composition with water to form a use solution; and applying the use solution to a surface in need of cleaning and/or rinsing, wherein the use solution provides from about 1 ppm to about 125 ppm active surfactant concentration.

In still another aspect, a method of dispensing a solid cleaning and/or rinse aid composition comprises: providing a solid composition as described herein; generating a use solution by contacting with an aqueous source; and dispensing the use solution to an application of use in need of a cleaning and/or rinse aid composition.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a graph of sheeting efficacy of individual nonionic surfactants compared to the solid polymer surfactants (containing the nonionic surfactant).

FIG. 2 shows additional sheeting efficacy studies conducted to evaluate the solid polymer surfactants.

FIG. 3 shows test data for 50 cycle redeposition evaluations of various surfactants compared to the solid polymer surfactants.

FIG. 4 shows test data for 50 cycle redeposition evaluations of various surfactants compared to the solid polymer surfactants.

FIG. 5 shows test data for 100 cycle film evaluations of various surfactants compared to the solid polymer surfactants.

FIG. 6 shows test data evaluating the dynamic contact angle of various surfactants compared to embodiments of the surfactant systems containing the solid polymer surfactants showing wetting on various substrate surfaces.

FIG. 7 shows test data evaluating the dynamic contact angle of various surfactants compared to embodiments of the surfactant systems containing the solid polymer surfactants showing wetting on various substrate surfaces.

FIG. 8 shows test data evaluating the impact of molecular weight of the polymers of the solid polymer surfactants on efficacy as rinse aid additives.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENT

The present invention relates to surfactant systems for various applications, including cleaning compositions and rinse aid applications. The inventive surfactant systems have many advantages over conventional combinations of surfactants.

The embodiments of this invention are not limited to particular applications of use for the inventive surfactant systems, which can vary and are understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range (e.g. 1 to 5 includes 1, 1.5, 2, 2.75, 3, 3.80, 4, and 5).

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment but may refer to the same embodiment. Further, as used in the following, the terms “preferably”, “more preferably”, “even more preferably”, “most preferably” and “in particular” or similar terms are used in conjunction with optional features, without restricting alternative possibilities. Thus, features introduced by these terms are optional features and are not intended to restrict the scope of the claims in any way.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts.

An “antiredeposition agent” refers to a compound that helps keep suspended in water instead of redepositing onto the object being cleaned. Antiredeposition agents are useful in the present invention to assist in reducing redepositing of the removed soil onto the surface being cleaned.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

The term “hard surface” refers to a solid, substantially non-flexible surface such as a counter top, tile, floor, wall, panel, window, plumbing fixture, kitchen and bathroom furniture, appliance, engine, circuit board, and dish. Hard surfaces may include for example, health care surfaces and food processing surfaces, instruments and the like.

As used herein, the term “phosphorus-free” or “substantially phosphorus-free” refers to a composition, mixture, or ingredient that does not contain phosphorus or a phosphorus-containing compound or to which phosphorus or a phosphorus-containing compound has not been added. Should phosphorus or a phosphorus-containing compound be present through contamination of a phosphorus-free composition, mixture, or ingredients, the amount of phosphorus shall be less than 0.5 wt-%. More preferably, the amount of phosphorus is less than 0.1 wt-%, and most preferably the amount of phosphorus is less than 0.01 wt %. Without being limited according to embodiments of the invention the surfactant systems and/or compositions employing the same may contain phosphates.

As used herein, the term “soil” or “stain” refers to a non-polar oily substance which may or may not contain particulate matter such as mineral clays, sand, natural mineral matter, carbon black, graphite, kaolin, environmental dust, etc.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “substantially similar cleaning performance” refers generally to achievement by a substitute cleaning product or substitute cleaning system of generally the same degree (or at least not a significantly lesser degree) of cleanliness or with generally the same expenditure (or at least not a significantly lesser expenditure) of effort, or both.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions according to the invention include but are not limited to, those that include polypropylene polymers (PP), polycarbonate polymers (PC), melamine formaldehyde resins or melamine resin (melamine), acrilonitrile-butadiene-styrene polymers (ABS), and polysulfone polymers (PS). Other exemplary plastics that can be cleaned using the compounds and compositions of the invention include polyethylene terephthalate (PET) and polystyrene polyamide.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The methods and compositions of the present invention may comprise, consist essentially of, or consist of the components and ingredients of the present invention as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

Compositions

The solid compositions according to the invention include at least a solid copolymer surfactant system for use in cleaning and rinsing plastics and other wares, along with a variety of other hard surfaces in need of a composition providing good sheeting, wetting and drying properties. In some aspects, the present invention provides compositions that can be used as rinse aids which are effective at reducing spotting and filming on a variety of substrates, particularly on plastic ware. In an aspect the compositions comprise, consist of or consist essentially of a solid copolymer surfactant system disclosed herein. In further aspects, the compositions further include an additional nonionic surfactant and/or additional functional ingredients.

In an aspect, the solid compositions provide desirable foam profiles as measured according to the Glewwe method wherein after 5 minutes a foam height of 5 inches or less is achieved, preferably less than 5 inches, more preferably 1 to 5 inches, more preferably 1 to 3 inches, and most preferably less than 1 inch of foam.

In an aspect, the solid compositions reduce the contact angles of the composition on a substrate surface by between about 5° to about 10°, or preferably between about 5° to about 20°, or more preferably between about 10° to about 25° as compared to the contact angle of a cleaning composition or rinse aid composition commercially available, namely a commercially available rinse aid composition not employing the solid copolymer surfactant systems or those that include both the copolymer and surfactant of the copolymer surfactant added to a composition as separate components as opposed to a copolymer surfactant. In a preferred aspect, the solid compositions reduce the contact angles of the composition on a polypropylene surface by between about 5° to about 10°, or preferably between about 5° to about 20°, or more preferably between about 10° to about 25° as compared to the contact angle of a commercially available rinse aid composition. Without wishing to be bound by any particular theory, it is thought that the lower the contact angle, the more a composition will induce sheeting. That is, compositions with lower contact angles will form droplets on a substrate with a larger surface area than compositions with higher contact angles. The increased surface area results in a faster drying time, with fewer spots formed on the substrate.

Solid Copolymer Surfactant Systems

In an aspect, the solid copolymer surfactant system includes a synergistic combination of the surfactant/polymer(s) to provide a solid system providing concentrated actives for enhanced cleaning, wetting, and sheeting that exceed conventional surfactant cleaners and rinse aids. In some embodiments the solid copolymer surfactant system comprises, consists of or consists essentially of a copolymer surfactant and an additional surfactant. In some embodiments the solid copolymer surfactant system comprises, consists of or consists essentially of a copolymer surfactant and a defoaming agent. In other embodiments the solid copolymer surfactant system comprises, consists of or consists essentially of a copolymer surfactant, an additional surfactant, and a defoaming agent.

In a preferred embodiment, the solid copolymer surfactant system comprises from about 50 wt-% to 99 wt-%, more preferably from about 50 wt-% to 90 wt-%, and most preferably from about 60 wt-% to 90 wt-% of the solid copolymer surfactant.

In a preferred embodiment, the solid polymer surfactant system comprises from about 1 wt-% to 50 wt-%, more preferably from about 10 wt-% to 50 wt-%, and most preferably from about 10 wt-% to 40 wt-% of the additional surfactant and/or polymer.

In an aspect, the solid copolymer surfactant systems provide desirable foam profiles as measured according to the Glewwe method wherein after 5 minutes a foam height of 5 inches or less is achieved, preferably less than 5 inches, more preferably 1 to 5 inches, more preferably 1 to 3 inches, and most preferably less than 1 inch of foam.

In an aspect, the solid copolymer surfactant systems reduce the contact angles of the composition on a substrate surface by between about 5° to about 10°, or preferably between about 5° to about 20°, or more preferably between about 10° to about 25° as compared to the contact angle of a cleaning composition or rinse aid composition commercially available, namely a commercially available rinse aid composition not employing the solid copolymer surfactant systems or those that include both the copolymer and surfactant of the copolymer surfactant added to a composition as separate components as opposed to a copolymer surfactant. In a preferred aspect, the solid copolymer surfactant systems reduce the contact angles of the composition on a polypropylene surface by between about 5° to about 10°, or preferably between about 5° to about 20°, or more preferably between about 10° to about 25° as compared to the contact angle of a commercially available rinse aid composition. Without wishing to be bound by any particular theory, it is thought that the lower the contact angle, the more a composition will induce sheeting. That is, compositions with lower contact angles will form droplets on a substrate with a larger surface area than compositions with higher contact angles. The increased surface area results in a faster drying time, with fewer spots formed on the substrate.

In some embodiments, the solid copolymer surfactant systems are selected to have certain environmentally friendly characteristics so they are suitable for use in food service industries and/or the like. For example, certain copolymer surfactant systems may meet environmental or food service regulatory requirements, for example, biodegradability requirements.

In an aspect, the solid polymer surfactant systems and compositions employing the solid polymer surfactant systems unexpectedly provide efficacy at lower doses, namely use concentrations of about 125 ppm or less of the polymer surfactant system actives (actives from all surfactants and/or polymers surfactants in the system), or 100 ppm or less, 50 ppm or less, or 25 ppm or less, due to the concentrated efficacy of the polymer surfactants employed therein. In an aspect, an actives concentration of less than about 5% provides effective performance. The solid polymer surfactant system allows dosing at lower actives level while providing at least substantially similar performance, as set forth in further detail in the Examples.

Solid Copolymer Surfactants

The copolymer surfactant is a solid comprising:
(i) at least one polymer P1) that comprises polymerized units of at least one monomer A) selected from the group consisting of α,β-ethylenically unsaturated carboxylic acids, salts of α,β-ethylenically unsaturated carboxylic acids, α,β-ethylenically unsaturated carboxylic acid anhydrides and mixtures thereof; and
(ii) at least one nonionic surfactant of the general formula (I),

R₁-(A)ₓ-(B)_{y1}-(A)_{z}-(B)_{y2}—R₂ (I),
wherein
R₁ and R₂ independently denote H or linear or branched, substituted or unsubstituted C1-C22 alkyl,
A denotes CH₂—CH₂—O,
B denotes CH₂—CHR₃—O, wherein R₃ denotes H or linear or branched, unsubstituted C1-C10 alkyl,
x is an integer in the range from 0 to 35,
y₁ is an integer in the range from 0 to 60,
y₂ is an integer in the range from 0 to 35, and
z is an integer in the range from 0 to 35,
wherein the sum of x+y₁+z+y₂ is at least 1.

The polymer surfactant can be characterized in that the solid polymer surfactant has a glass transition temperature (Tg) of at least 50° C., in the range of 50° C. to 130° C., in the range of 60° C. to 120° C., or in the range of 70° C. to 120° C., determined by differential scanning calorimetry according to DIN EN ISO 11357-2, at a heating rate of 20 K/min.

The term ‘solid’ as used for the solid polymer surfactant refers to the physical state in a solid form under the standard conditions (23° C., 1 bar).

The glass transition temperatures (Tg) described herein is determined by means of differential scanning calorimetry (DSC). The DSC analysis on one and the same sample is appropriately repeated once or twice, in order to ensure a defined thermal history of the respective surfactant-polymer compositions. The heating and cooling rates are 20 K/min.

Polymer P1

The at least one polymer P1) comprises polymerized units of at least one monomer A), selected from the group consisting of α,β-ethylenically unsaturated carboxylic acids, salt of α,β-ethylenically unsaturated carboxylic acids, α,β-ethylenically unsaturated carboxylic acid anhydrides and mixtures thereof.

As used herein, the term “polymer” generally denotes a molecule having monomer units between five and a hundred. It includes, but is not limited to, homopolymers, copolymers, such as for example, block, graft, random and alternating co-polymers. Furthermore, unless other-wise specifically limited, the term “polymer” shall include all possible isomeric configurations of the monomers, including, but are not limited to isotactic, syndiotactic and random symmetries configurations, and combinations thereof. Furthermore, unless otherwise specifically limited, the term “polymer” shall include all possible geometrical configurations of the molecule.

The α,β-ethylenically unsaturated carboxylic acids are preferably selected from acrylic acid, methacrylic acid, ethacrylic acid, maleic acid, fumaric acid, itaconic acid, α-chloroacrylic acid, crotonic acid, citraconic acid, mesaconic acid, glutaconic acid and aconitic acid. Suitable salts of the aforementioned acids are, in particular, the sodium, potassium, ammonium and sodium phosphonate salts.

Preferably, the α,β-ethylenically unsaturated carboxylic acids are used for the polymerization in non-neutralized form. If the α,β-ethylenically unsaturated carboxylic acids are used for the polymerization in partially neutralized form, then the acid groups are neutralized, preferably to at most 50 mol %, particularly preferably to at most 30 mol %. Preferred α,β-ethylenically unsaturated carboxylic acid anhydrides are selected from the group consisting of acrylic anhydride, methacrylic anhydride, maleic anhydride, itaconic an-hydride, citraconic anhydride and 2,3-dimethylmaleic anhydride.

In a more preferred embodiment, the monomer A) is selected from the group consisting of α,β-ethylenically unsaturated carboxylic acids, salts of α,β-ethylenically unsaturated carboxylic acids and mixtures thereof.

In a more preferred embodiment, the at least one monomer A) is selected from the group consisting of acrylic acid, methacrylic acid, maleic acid, fumaric acid, itaconic acid, ethacrylic acid, α-chloroacrylic acid, crotonic acid, citraconic acid, mesaconic acid, glutaconic acid, ac-onitic acid, maleic anhydride, itaconic anhydride and salts thereof. Most preferably, the monomer A) is selected from the group consisting of acrylic acid, methacrylic acid, maleic acid, fumaric acid, itaconic acid, salts of the aforementioned carboxylic acids and mixtures thereof.

The at least one polymer P1) may optionally comprise polymerized units of at least one monomer B) which is selected from the group consisting of unsaturated phosphonic acids, salts of unsaturated phosphonic acids, sodium phosphinate and mixtures thereof. In an embodiment, the at least one monomer B) is selected from the group consisting of vinyl phosphonic acid, allyl phosphonic acid, sodium phosphinate, salts and mixtures thereof. In a preferred embodiment, the at least one monomer B) is sodium phosphinate.

In an embodiment, the at least one polymer P1) is obtained by free-radical polymerization of at least one monomer A). In another embodiment, the at least one polymer P1) is obtained by free-radical polymerization of at least one monomer B). In a preferred embodiment, the at least one polymer P1) is obtained by free-radical polymerization of at least one monomer A), at least one monomer B) and mixtures thereof.

In an embodiment, the at least one polymer P1) is a homopolymer or a copolymer of at least one monomer A), at least one monomer B) and mixtures thereof. In a preferred embodiment, the at least one polymer P1) is a homopolymer or a copolymer of acrylic acid, methacrylic acid, salts of acrylic acid, salts of methacrylic acid and sodium phosphinate. In a more preferred embodiment, the at least one polymer P1) is a homopolymer of acrylic acid. In a more preferred embodiment, the at least one polymer P1) is represented by the general formula (II)

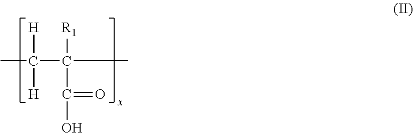

wherein
R₁ is selected from H and methyl; and
x is an integer in the range of 10 to 100.

In a most preferred embodiment of the at least one polymer P1) of general formula (II), R₁ is H and x is an integer in the range of 20 to 70.

In another preferred embodiment, the at least one polymer P1) is a copolymer of acrylic acid and sodium phosphinate. In a more preferred embodiment, the at least one polymer P1) is represented by general formula (III).

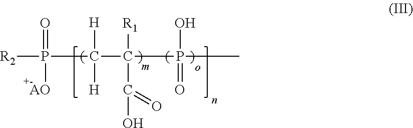

wherein
R₁ is selected from H and methyl;
R₂ is selected from H and —(—CH₂—CR₁COOH—)ₘ;
A is selected from H, sodium and potassium;
m is an integer in the range of 5 to 60;
n is an integer in the range of 1 to 60; and
o is 0 or 1.

Some of the terminal groups of the at least one polymer P1) of general formula (III) may be carboxylate, but most are preferably phosphonate as represented in structure (III). The at least one polymer P1) of the general formula (III) can be prepared by the reaction of acrylic acid and sodium hypophosphite in the presence of a free radical initiator. For example, low molecular weight polyphosphinoacrylic acid may be prepared by a slow addition of acrylic acid to an aqueous solution of sodium hypophosphite containing a catalytic amount of potassium persulfate at 90° C. to 95° C. under nitrogen atmosphere.

In a preferred embodiment, the at least one polymer P1) of the general formula (III) has a weight average molecular weight in the range of 300 to 8000 g/mol, more preferably in the range of 500 to 7000 g/mol, still more preferably in the range of 1000 to 6000 g/mol and most preferably in the range of 1500 to 5000 g/mol. The reaction products prepared at 40 percent solids are clear to slightly hazy aqueous solutions with a pH of 2.5 to 3.0. By varying the concentration of sodium hypophosphite and rate of acrylic acid addition, products having weight average molecular weights from 1500 to 5000 are readily obtained.

In another preferred embodiment, the at least one polymer P1) is a polymeric complex comprising a copolymer of acrylic acid and sodium phosphinate salt. In a more preferred embodiment, the at least one polymer P1) is represented by general formula (IV)

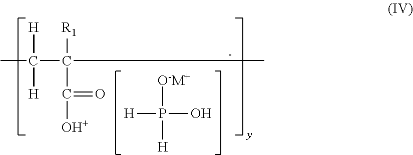

wherein
R₁ is selected from H and methyl;
y is an integer in the range of 5 to 60; and
M is selected from sodium, potassium, ammonium and amino.

In a preferred embodiment of the at least one polymer of general formula (IV), R₁ is H and M is sodium. A particularly preferred polymeric complex of this type is 2-propenoic acid, complexed with sodium phosphinate.

In a more preferred embodiment, the at least one polymer P1) is selected from the group consisting of homopolymer of acrylic acid and copolymers of acrylic acid and sodium phosphinate. In a more preferred embodiment, the at least one polymer P1) is represented by general formula (II), (III), (IV) and mixtures thereof.

Number-average molecular weight (Mₙ), weight-average molecular weight (M_{w}) and polydispersity of the polymer P1) are determined by gel permeation chromatography (GPC): Eluent 0.01 mol/l phosphate buffer, column set of 2 separating columns of column length 30 cm each, column temperature 35° C., pH=7.4, +0.01 M NaN₃ in deionized water. For calibration, polyacrylic acid (neutralized) standard is used. Flow rate is 0.8 mL/min, concentration 2 mg/mL, injection 100 μL. Detector: RID (Refractive Index Detector) Agilent 1200”.

In an embodiment, the at least one polymer P1) has a number-average molecular weight (Mₙ) in the range of 1,000 to 30,000 g/mol as determined by gel permeation chromatography.

In a more preferred embodiment, the at least one polymer P1) has a number-average molecular weight (Mₙ) in the range of 1,000 to 25,000 g/mol as determined by gel permeation chromatography. In a most preferred embodiment, the at least one polymer P1) has a number-average molecular weight (Mₙ) in the range of 1,000 to 20,000 g/mol as determined by gel permeation chromatography. In an embodiment, the at least one polymer P1) has a weight average molecular weight (M_{w}) in the range of 1,000 to 40,000 g/mol as determined by gel permeation chromatography. In a more preferred embodiment, the at least one polymer P1) has a weight average molecular weight (M_{w}) in the range of 1,000 to 35,000 g/mol as determined by gel permeation chromatography. In a most preferred embodiment, the at least one polymer P1) has a weight average molecular weight (M_{w}) in the range of 1,000 to 30,000 g/mol as determined by gel permeation chromatography.

Polydispersity refers to M_{w}/Mₙ, or ratio of weight average molecular weight to number average molecular weight. In a preferred embodiment, the polymer P1) has a polydispersity in the range of 1.2 to 3.0, more preferably in the range of 1.3 to 2.8 and most preferably in the range of 1.3 to 2.5, as determined by gel permeation chromatography.

In an embodiment, the pH of 10% aqueous solution of the at least one polymer P1) is in the range of 2 to 4. The pH is measured with a glass electrode and a pH meter.

In a preferred embodiment, the at least one polymer P1) is present in an amount in the range of 20% to 80% by weight, more preferably in the range of 22% to 78% by weight, and most preferably in the range of 23% to 76% by weight, in each case based on the total weight of the solid polymer surfactant.

Surfactant

The at least one nonionic surfactant of the polymer surfactant is the compound of the general formula (I), R₁-(A)ₓ-(B)_{y1}-(A)_{z}-(B)_{y2}—R₂ (I), wherein R₁ and R₂ independently denote H or linear or branched, substituted or unsubstituted C1-C22 alkyl,
A denotes CH₂—CH₂—O,
B denotes CH₂—CHR₃—O, wherein R₃ denotes H or linear or branched, unsubstituted C1-C10 alkyl,
x is an integer in the range from 0 to 35,
y₁ is an integer in the range from 0 to 60,
y₂ is an integer in the range from 0 to 35,
z is an integer in the range from 0 to 35, and
wherein the sum of x+y₁+z+y₂ is at least 1.

Preferably the sum of x+y₁+z+y₂is in the range of 1 to100, more preferably the sum of x+y₁+z+y₂ is in the range of 1 to 75 even more preferably the sum of x+y₁+z+y₂ is in the range of 2 to 75 and most preferably the sum of x+y₁+z+y₂is in the range of 2 to 70.

Within the context of the present invention, the term “alkyl,” as used herein, refers to acyclic saturated aliphatic residues, including linear or branched alkyl residues. Furthermore, the alkyl residue is preferably unsubstituted and includes as in the case of C₁-C₂₂alkyl 1 to 22 carbon atoms.

As used herein, “branched” denotes a chain of atoms with one or more side chains attached to it. Branching occurs by the replacement of a substituent, e.g., a hydrogen atom, with a covalently bonded aliphatic moiety.

Representative examples of linear and branched, unsubstituted C₁-C₂₂ alkyl include, but are not limited to methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-hepta-decyl, n-octadecyl, n-nonadecyl, n-eicosyl, n-heneicosyl, n-docosyl, isopropyl, isobutyl, iso-pentyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoe-icosyl, isoheneicosyl, isodocosyl, 2-propyl heptyl, 2-ethyl hexyl and t-butyl.

The preferred embodiments A to E of the at least one nonionic surfactant of general formula (I) according to the presently claimed invention are summarized in Table 1 below:

TABLE 1

| | Compound of general formula (I) | | | | |
|---|---|---|---|---|---|
| | A | B | C | D | E |
| R1 | Linear or | H | Linear or | Linear or | H |
| | branched, | | branched, | branched, | |
| | unsubstituted | | unsubstituted | unsubstituted | |
| | C1-C22 alkyl | | C1-C22 alkyl | C1-C22 alkyl | |
| R2 | H | H | H or linear or | C1-C22 alkyl | H |
| | | | branched, | | |
| | | | unsubstituted | | |
| | | | C1-C10 alkyl | | |
| R3 | H or linear or | Linear or | H or linear or | H or linear or | H or linear or |
| | branched, | branched, | branched, | branched, | branched, |
| | unsubstituted | unsubstituted | unsubstituted | unsubstituted | unsubstituted |
| | C1-C10 alkyl | C1-C10 alkyl | C1-C10 alkyl | C1-C10 alkyl | C1-C10 alkyl |
| x | 0 to 30 | 1 to 25 | 1 to 25 | 1 to 25 | 0 |
| y1 | 0 to 30 | 5 to 60 | 0 to 30 | 1 to 30 | 1 to 30 |
| y2 | 0 to 30 | 0 | 0 | 0 | 1 to 30 |
| z | 0 to 30 | 1 to 25 | 0 | 0 to 20 | 1 to 20 |
| x + y1 + | 1 to 70 | 1 to 100 | 1 to 55 | 1 to 75 | 1 to 80 |
| z + y2 | | | | | |

The more preferred embodiments F to J of the at least one nonionic surfactant of general formula (I) are summarized in the Table 2 below:

TABLE 2

| | Compound of general formula (I) | | | | |
|---|---|---|---|---|---|
| | F | G | H | I | J |
| R1 | Linear or | H | Linear or | Linear or | H |
| | branched, | | branched, | branched, | |
| | unsubstituted | | unsubstituted | unsubstituted | |
| | C4-C22 alkyl | | C1-C22 alkyl | C1-C22 alkyl | |
| R2 | H | H | H or linear or | C1-C22 alkyl | H |
| | | | branched, | | |
| | | | unsubstituted | | |
| | | | C1-C5 alkyl | | |
| R3 | Linear or | Linear or | H or linear or | Linear or | methyl |
| | branched, | branched, | branched, | branched, | |
| | unsubstituted | unsubstituted | unsubstituted | unsubstituted | |
| | C1-C10 alkyl | C1-C5 alkyl | C1-C5 alky | C1-C10 alkyl | |
| x | 0 to 25 | 1 to 20 | 1 to 25 | 1 to 20 | 0 |
| y1 | 1 to 25 | 5 to 60 | 0 to 20 | 1 to 25 | 5 to 30 |
| y2 | 0 to 25 | 0 | 0 | 0 | 5 to 30 |
| z | 0 to 25 | 1 to 15 | 0 | 0 to 15 | 3 to 20 |
| x + y1 + | 1 to 60 | 1 to 70 | 1 to 30 | 1 to 70 | 1 to 75 |
| z + y2 | | | | | |

The most preferred embodiments K to O of the at least one nonionic surfactant of general formula (I) are summarized in the Table 3 below:

TABLE 3

| | Compound of general formula (I) | | | | |
|---|---|---|---|---|---|
| | K | L | M | N | O |
| R1 | Linear or | H | Linear or | Linear or | H |
| | branched, | | branched, | branched, | |
| | unsubstituted | | unsubstituted | unsubstituted | |
| | C8-C20 alkyl | | C1-C22 alkyl | C1-C22 alkyl | |
| R2 | H | H | H or linear, | C1-C22 alkyl | H |
| | | | unsubstituted | | |
| | | | C1-C4 alkyl | | |
| R3 | Linear or | methyl | H or methyl | Linear or | methyl |
| | branched, | | | branched, | |
| | unsubstituted | | | unsubstituted | |
| | C1 to C5 alkyl | | | C1-C10 alkyl | |
| x | 0 to 20 | 1 to 15 | 1 to 20 | 1 to 15 | 0 |
| y1 | 1 to 20 | 5 to 55 | 0 to 15 | 1 to 20 | 10 to 30 |
| y2 | 0 to 20 | 0 | 0 | 0 | 10 to 30 |
| z | 0 to 20 | 1 to 10 | 0 | 0 to 10 | 3 to 18 |
| x + y1 + | 1 to 50 | 1 to 60 | 1 to 20 | 1 to 65 | 1 to 70 |
| z + y2 | | | | | |

The at least one nonionic surfactant of general formula (I) according to embodiments A, F and K can be prepared by alkoxylation of fatty alcohol R₁—OH. When the fatty alcohol R₁—OH is derived from a natural source, it is common to have mixtures, e.g. of C₁₀ and C₁₆ alcohols, C₁₆ and C₁₈ alcohols or C₁₂ and C₁₄ alcohols. Fatty alcohol R₁—OH can also be synthesized (for example by oxo process) from olefin mixtures and in this case, it is common to have mix-tures e.g. of C₁₃ and C₁₅ alcohols.

The at least one nonionic surfactant of general formula (I) according to embodiments B, G and L are the block copolymers of propylene oxide and ethylene oxide wherein the copolymers include first and second blocks of repeating ethylene oxide (EO) units and a block of repeating propylene oxide (PO) unit interposed between first and second block of repeating ethylene units represented by formula (V),

HO—(CH₂CH₂O)ₓ(CH(CH₃)CH₂O)_{y1}(CH₂CH₂O)_{z}—H; (V)

In a preferred embodiment, the at least one nonionic surfactant of general formula (I) ac-cording to embodiments B, G and L have a ratio of ethylene oxide (EO) units to propylene oxide (PO) units of from 1:10 to 10:1 and an average molecular weight from 500 to 10,000 g/mol.

The at least one nonionic surfactant of general formula (I) according to embodiments C, H and M are the block copolymers of ethylene oxide and higher alkylene oxide functionalized/capped with fatty alcohols. Preferred higher alkylene oxides are propylene oxide, butylene oxide and pentylene oxide. The preferred ratio of ethylene oxide to the higher alkylene oxide units is 1:2 to 5:2.

The at least one nonionic surfactant of general formula (I) according to embodiments E, J and O are the block copolymers of propylene oxide and ethylene oxide wherein the copolymers include first and second blocks of repeating propylene oxide (PO) units and a block of repeating ethylene oxide (EO) unit interposed between first and second block of repeating propylene units as represented by formula (VI),

HO—(CH(CH₃)CH₂O)_{y1}—(CH₂CH₂O)_{z}—(CH(CH₃)CH₂O)_{y2}—H. (VI)

In a preferred embodiment, the at least one nonionic surfactant of general formula (I) according to embodiments E, J and O have a ratio of ethylene oxide (EO) units to propylene oxide (PO) units of from 1:10 to 10:1 and an average molecular weight from 500 to 10,000 g/mol.

Suitable nonionic surfactant of the general formula (I) are as listed in Table 4.

TABLE 4

| | | | | | | | | HLB |
|---|---|---|---|---|---|---|---|---|
| | R₁ | x | y₁ | z | y₂ | R₂ | R₃ | value |
| Surfactant 1 | C₁₀ branched, | 0 | 3 | 15 | 18 | H | methyl | 6.40 |
| | unsubstituted | | | | | | | |
| Surfactant 2 | C₁₃-C₁₅, linear & | 9.8 | 2.1 | 0 | 0 | H | ethyl | 10.5 |
| | branched, | | | | | | | |
| | unsubstituted | | | | | | | |
| Surfactant 3 | C₁₃-C₁₅, linear & | 6.1 | 1.9 | 0 | 0 | H | ethyl | 8.90 |
| | branched, | | | | | | | |
| | unsubstituted | | | | | | | |
| Surfactant 4 | C₁₃-C₁₅ | 4.8 | 2 | 0 | 0 | H | ethyl | 7.7 |
| | branched, | | | | | | | |
| | unsubstituted | | | | | | | |
| Surfactant 5 | C₁₃-C₁₅, linear & | 0 | 5 | 2.5 | 0 | H | methyl | 3.4 |
| | branched, | | | | | | | |
| | unsubstituted | | | | | | | |
| Surfactant 6 | C₁₃-C₁₅, linear & | 3.5 | 5.5 | 0 | 0 | H | methyl | 4.80 |
| | branched, | | | | | | | |
| | unsubstituted | | | | | | | |
| Surfactant 7 | C₁₀ branched, | 5.4 | 4.7 | 0.5 | 0 | H | methyl | 7.60 |
| | unsubstituted | | | | | | | |
| Surfactant 8 | C₁₆-C₁₈, linear & | 3.9 | 14 | 0 | 0 | H | methyl | 2.80 |
| | branched, | | | | | | | |
| | unsubstituted | | | | | | | |
| Surfactant 9 | C₁₂-C₁₄, linear & | 3 | 6 | 0 | 0 | H | methyl | 3.90 |
| | branched, | | | | | | | |
| | unsubstituted | | | | | | | |
| Surfactant 10 | C₁₂-C₁₈, linear and | 10 | 0 | 0 | 0 | butyl | H | 12.70 |
| | branched, | | | | | | | |
| | unsubstituted | | | | | | | |
| Surfactant 11 | H | 2 | 16 | 1 | 0 | H | methyl | 2.00 |
| Surfactant 12 | H | 2 | 26 | 1 | 0 | H | methyl | 2.00 |
| Surfactant 13 | H | | | 1 | 0 | H | methyl | 2.00 |
| Surfactant 14 | H | 5 | 47 | 1 | 0 | H | methyl | 2.00 |
| Surfactant 15 | H | 0 | 20-25 | 5-15 | 20-25 | H | methyl | 4.00 |
| Surfactant 16 | C₁₃ branched, | 2 | 0 | 0 | 0 | H | — | 6.1 |
| | unsubstituted | | | | | | | |

In an embodiment, the at least one nonionic surfactant of the general formula (I) has a hydrophilic-lipophilic balance (HLB) value in the range of 2 to 17.

In a preferred embodiment, the at least one nonionic surfactant of the general formula (I) has an HLB value in the range of 2 to 11 when R₂ is H.

In another preferred embodiment, the at least one nonionic surfactant of the general formula (I) has an HLB value in the range of 2 to 17 when R₂ is linear or branched, substituted or unsubstituted C₁-C₂₂ alkyl.

The HLB value represents the hydrophilic-lipophilic balance of the molecule. The lower the HLB value the more hydrophobic the material is, and vice versa. The HLB values can be calculated according to the method given in Griffin, J. Soc. Cosmetic Chemists, 5 (1954) 249-256. Griffith's method for nonionic surfactants as described in 1954 is as follows: HLB=20 X Mₕ/M, where Mₕ is the molecular mass of the hydrophilic portion of the molecule; and M is the molecular mass of the whole molecule. Only the EO part in the surfactants is regarded as hydrophilic, all other parts contribute only to the whole molecule.

In a preferred embodiment, the at least one nonionic surfactant is present in an amount in the range of 20% to 80% by weight, more preferably in the range of 22% to 78% by weight, and most preferably in the range of 23% to 76% by weight, in each case based on the total weight of the solid polymer surfactant.

Additional Surfactants

In some embodiments, the solid copolymer surfactant systems include an additional surfactant or polymer surfactant combined with the copolymer surfactants described above. Additional surfactants and/or polymer surfactants suitable for use with the compositions of the present invention include, but are not limited to, nonionic surfactants. In some embodiments, the solid copolymer surfactant systems comprise from about 1 wt-% to about 50 wt-% additional surfactant, 10 wt-% to about 50 wt-% additional surfactant, or 10 wt-%. to about 40 wt-% additional surfactant.

In some embodiments, the solid copolymer surfactant system comprises at least about 10 wt-% total surfactant concentration, at least about 10 wt-% total surfactant concentration, at least about 15 wt-% total surfactant concentration, at least about 20 wt-% total surfactant concentration, at least about 25 wt-% total surfactant concentration, at least about 30 wt-% total surfactant concentration, at least about 35 wt-% total surfactant concentration, at least about 40 wt-% total surfactant concentration, at least about 50 wt-% total surfactant concentration, at least about 60 wt-% total surfactant concentration, or at least about 70 wt-% total surfactant concentration. As referred to herein, total surfactant concentration includes active surfactant concentration from the surfactant portion of the solid copolymer surfactant and the additional surfactant or polymer surfactant.

Exemplary nonionic surfactants (A-E) and polymer surfactants (F-J) are shown in Table 5.

TABLE 5

| | | |
|---|---|---|
| A | R¹—O—(EO)ₓ₃(PO)_{y3}—H | R¹ = straight-chain C₁₀-C₁₆- |
| | | alkyl, |
| | | x₃ = 5-8, preferably 5.5-7, = |
| | | y₃ = 2-5, preferably 2-3.5 |
| A2 | R¹—O—(EO)ₓ₄(PO)_{y4}—H | R¹ = a straight-chain |
| | | C₁₀-C₁₆-alkyl, |
| | | x₄ = 4-8, preferably 4-5.5, = |
| | | y₄ = 2-5, preferably 3.5-5 |
| B | R²—O—(EO)ₓ₁—H | R² = C₁₀-C₁₄ alkyl, or |
| | | preferably a C₁₂-C₁₄ alkyl, |
| | | with an average at least 1 |
| | | branch per residue, or |
| | | preferably at least 2 |
| | | branches per residue, and |
| | | x₁ = 5-10 |
| C | R²—O—(EO)ₓ₂—H | R² = C₁₀-C₁₄ alkyl, or |
| | | preferably a C₁₂-C₁₄ alkyl |
| | | with an average at least 1 |
| | | branch per residue, or |
| | | preferably at least 2 |
| | | branches per residue, |
| | | x₂ = 2-4 |
| D | R⁷—O—(PO)y₅(EO)x₅(PO)y₆ | R7 = C₈-C₁₆ Guerbet |
| | | alcohol, preferably a C₈₋₁₂ |
| | | Guerbet alcohol, or more |
| | | preferably a C₈-C₁₀ Guerbet |
| | | alcohol, |
| | | x₅ = 5-30, preferably 9-22, |
| | | y₅ = 1-5, preferably 1-4, |
| | | y₆ = 10-20 |
| E | R⁶—O—(PO)y₄(EO)x₄ | R⁶ = C₈-C₁₆ Guerbet |
| | | alcohol, preferably a C₈₋₁₂ |
| | | Guerbet alcohol, or more |
| | | preferably a C₈-C₁₀ Guerbet |
| | | alcohol, |
| | | x₄ = 2-10, preferably 3-8, |
| | | y₄ = 1-2 |
| F | 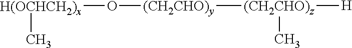 | x = 12-20 y = 120-220 z = 12-20 |
| G | 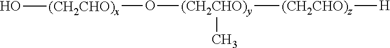 | x = 88-108 y = 57-77 z = 88-108 |
| H | 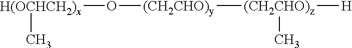 | x = 15-25 y = 10-25 z = 15-25 |
| I | R⁴—O—(EO)ₓ(XO)_{y}—H | R4 = C13-C15 alkyl |
| | | x = 8-10 |
| | | y = 1-3 |
| | | and XO = Butylene oxide |
| J | R⁵—O—(EO)ₓ(PO)_{y}—H | R5 = C12-15 alkyl |
| | | x = 3-5 |
| | | y = 5-7 |

Still further additional useful nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water soluble compound having the desired degree of balance between hydrophilic and hydrophobic properties. Useful nonionic surfactants include:

Block polyoxypropylene-polyoxyethylene polymeric compounds based upon propylene glycol, ethylene glycol, glycerol, trimethylolpropane, and ethylenediamine as the initiator reactive hydrogen compound (1). Examples of polymeric compounds made from a sequential propoxylation and ethoxylation of initiator are commercially available from BASF Corp. One class of compounds is difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Another class of compounds are tetra-flinctional block copolymers derived from the sequential addition of propylene oxide and ethylene oxide to ethylenediamine. The molecular weight of the propylene oxide hydrotype ranges from about 500 to about 7,000; and, the hydrophile, ethylene oxide, is added to constitute from about 10% by weight to about 80% by weight of the molecule.

Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide (2). The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

Condensation products of one mole of a saturated or unsaturated, straight or branched chain alcohol having from about 6 to about 24 carbon atoms with from about 3 to about 50 moles of ethylene oxide (3). The alcohol moiety can consist of mixtures of alcohols in the above delineated carbon range or it can consist of an alcohol having a specific number of carbon atoms within this range. Condensation products of one mole of saturated or unsaturated, straight or branched chain carboxylic acid having from about 8 to about 18 carbon atoms with from about 6 to about 50 moles of ethylene oxide (4). The acid moiety can consist of mixtures of acids in the above defined carbon atoms range or it can consist of an acid having a specific number of carbon atoms within the range. In addition to ethoxylated carboxylic acids, commonly called polyethylene glycol esters, other alkanoic acid esters formed by reaction with glycerides, glycerin, and polyhydric (saccharide or sorbitan/sorbitol) alcohols have application in this invention for specialized embodiments, particularly indirect food additive applications. All of these ester moieties have one or more reactive hydrogen sites on their molecule which can undergo further acylation or ethylene oxide (alkoxide) addition to control the hydrophilicity of these substances. Care must be exercised when adding these fatty ester or acylated carbohydrates to compositions of the present invention containing amylase and/or lipase enzymes because of potential incompatibility.

Examples of nonionic low foaming surfactants include:

Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. The hydrophobic portion of the molecule weighs from about 2,100 to about 6,700 with the central hydrophile including 10% by weight to 80% by weight of the final molecule. Compounds from groups (1), (2), (3) and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional examples of effective low foaming nonionics include:

The alkylphenoxypolyethoxyalkanols of U.S. Pat. No. 2,903,486 issued Sep. 8, 1959 to Brown et al. and represented by the formula

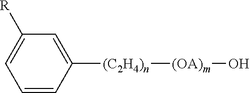

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968 to Lissant et al. having the general formula Z[(OR)ₙOH]_{z} wherein Z is alkoxylatable material, R is a radical derived from an alkylene oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954 to Jackson et al. corresponding to the formula Y(C₃H₆O)ₙ(C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ(C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerine, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents which are advantageously used in the compositions of this invention correspond to the formula: P[(C₃H₆O)ₙ(C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

Polyhydroxy fatty acid amide surfactants suitable for use in the present compositions include those having the structural formula R₂CON_{R1}Z in which: R₁ is H, C₁-C₄ hydrocarbyl, 2-hydroxy ethyl, 2-hydroxy propyl, ethoxy, propoxy group, or a mixture thereof; R₂ is a C₅-C₃₁ hydrocarbyl, which can be straight-chain; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

The ethoxylated C₆-C₁₈ fatty alcohols and C₆-C₁₈ mixed ethoxylated and propoxylated fatty alcohols are suitable surfactants for use in the present compositions, particularly those that are water soluble. Suitable ethoxylated fatty alcohols include the C₆-C₁₈ ethoxylated fatty alcohols with a degree of ethoxylation of from 3 to 50.

Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

Fatty acid amide surfactants suitable for use the present compositions include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)_{X}H, where x is in the range of from 1 to 3.

A useful class of non-ionic surfactants includes the class defined as alkoxylated amines or, most particularly, alcohol alkoxylated/aminated/alkoxylated surfactants. These non-ionic surfactants may be at least in part represented by the general formulae: R²⁰—(PO)_{S}N-(EO)ₜH, R²⁰—(PO)_{S}N-(EO)ₜH(EO)ₜH, and R²⁰—N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰—(PO)_{V}—N[(EO)_{w}H][(EO)_{z}H] in which R²⁰ is as defined above, v is 1 to 20 (e.g., 1, 2, 3, or 4 (preferably 2)), and w and z are independently 1-10, preferably 2-5.

The treatise Nonionic Surfactants, edited by Schick, M. J., Vol. 1 of the Surfactant Science Series, Marcel Dekker, Inc., New York, 1983 is an excellent reference on the wide variety of nonionic compounds generally employed in the practice of the present invention. A typical listing of nonionic classes, and species of these surfactants, is given in U.S. Pat. No. 3,929,678 issued to Laughlin and Heuring on Dec. 30, 1975. Further examples are given in “Surface Active Agents and detergents” (Vol. I and II by Schwartz, Perry and Berch).

In an aspect, the surfactant system comprises, consists of and/or consists essentially any combination of the solid polymer surfactants and one or more surfactants described herein, preferably nonionic surfactants.

In an aspect, in each of the aforementioned surfactant systems, the desired properties of sheeting, wetting and drying are achieved through formulations having desirable contact agent and foam profiles.

Compositions Employing Surfactant Systems

The surfactant systems and compositions employing surfactant systems are formulated into solid formulations. In a preferred embodiment, the surfactant systems and compositions are formulated to include components that are suitable for use in food service industries, e.g., GRAS ingredients, a partial listing is available at 21 CFR 184. In some embodiments, the surfactant systems and compositions are formulated to include only GRAS ingredients. In other embodiments, the surfactant systems and compositions are formulated to include GRAS and biodegradable ingredients. In other embodiments this is not a requirement.

The solid polymer surfactant systems and compositions employing the surfactant systems in a use solution preferably have a pH of 8.5 or below, 8.3 or below, or 7 or below in a use solution (i.e. diluted with water that has a pH of about 9). As a further benefit of the compositions and methods described herein, a use solution pH of less than 8.5 further inhibits scale inhibition in treated systems and surfaces.

The solid polymer surfactant systems and compositions employing the surfactant systems in a use solution preferably have a concentration of about 125 ppm or less of the surfactant system actives, or 100 ppm or less, or 50 ppm or less, due to the synergy of the systems according to the benefits of the invention. The solid polymer surfactant systems and compositions employing the surfactant systems allow dosing at lower actives level while providing at least substantially similar performance.

In various aspect of the solid compositions comprising the solid polymer surfactant compositions at least one additional functional ingredient is included in the solid composition. The combination of the solid polymer surfactant system and the additional functional ingredient(s) beneficially provides a foam profile of the composition having a foam height of less than 5 inches after 5 minutes using the Glewwe method. In a further aspect, the combination of the solid polymer surfactant system and the additional functional ingredient(s) is plastic-compatible providing sheeting, wetting and drying properties which at least equivalent or superior to a commercially available rinse aid composition at a lower ppm actives of the surfactant system. In other embodiments, the combination of the solid polymer surfactant system and the additional functional ingredients(s) provide efficacious cleaning, sheeting, wetting and/or drying properties at a lower ppm actives of about 125 ppm compared to conventional surfactant systems while beneficially allowing formulation into a solid composition.

In some embodiments, the solid composition comprises at least about 10 wt-% total surfactant concentration, at least about 15 wt-% total surfactant concentration, at least about 20 wt-% total surfactant concentration, at least about 25 wt-% total surfactant concentration, at least about 30 wt-% total surfactant concentration, at least about 35 wt-% total surfactant concentration, at least about 40 wt-% total surfactant concentration, at least about 50 wt-% total surfactant concentration, at least about 60 wt-% total surfactant concentration, or at least about 70 wt-% total surfactant concentration. As referred to herein, total surfactant concentration includes active surfactant concentration from the surfactant portion of the solid copolymer surfactant and any additional surfactant or polymer surfactants in the solid compositions. In some embodiments, pressed solid compositions may comprise at least about 15 wt-% total surfactant concentration. In other embodiments, cast solid compositions may comprise at least about 40 wt-% total surfactant concentration. In still other embodiments, extruded solid compositions may comprise at least about 50 wt-% total surfactant concentration.

Additional Functional Ingredients

The solid composition can further be combined with various functional components suitable for use in rinse aid applications, ware wash applications, and other applications requiring sheeting, wetting, and fast drying of surfaces. In some embodiments, the solid polymer surfactant system composition makes up a large amount, or even substantially all of the total weight of the solid composition. For example, in some embodiments few or no additional functional ingredients are disposed therein. In other embodiments, additional functional ingredients may be included in the compositions to provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in rinsing and cleaning applications. However, other embodiments may include functional ingredients for use in other applications.

In some embodiments, the compositions include from about 0.1 wt-% to about 90 wt-% additional functional ingredients, from about 1 wt-% to about 90 wt-% additional functional ingredients, from about 5 wt-% to about 90 wt-% additional functional ingredients, from about 10 wt-% to about 90 wt-% additional functional ingredients, from about 20 wt-% to about 90 wt-% additional functional ingredients, from about 20 wt-% to about 70 wt-% additional functional ingredients, from about 20 wt-% to about 60 wt-% additional functional ingredients, or from about 25 wt-% to about 50 wt-% additional functional ingredients.

In some embodiments, the compositions do not include a defoaming agent. In other embodiments, the compositions include less than about 30 wt-%, or less than about 20 wt-% defoaming surfactant or defoaming agent, or less than about 10 wt-% defoaming surfactant or defoaming agent, or preferably less than about 5 wt-% defoaming surfactant or defoaming agent to provide an effective amount of defoamer component configured for reducing the stability of foam that may be created by the surfactant system. Exemplary defoaming agents include for example nonionic EO containing surfactants that are hydrophilic and water soluble at relatively low temperatures, for example, temperatures below the temperatures at which the rinse aid will be used. Without being limited to a particular mechanism of action the inclusion of a defoaming agent may negatively interact with the solid polymer surfactant system as increasing amounts of defoamer demonstrate an antagonist effect of diminished efficacy due to interference with wetting and sheeting in the solid polymer surfactant systems according to the invention. In other embodiments, the inclusion of a defoaming agent may negatively interfere with formulating the surfactant systems into solid compositions as a result of additional liquid components into the compositions.

In other embodiments, the compositions may include carriers, water conditioning agents including rinse aid polymers, binding agents for solidification, anti-redeposition agents, antimicrobial agents, bleaching or whitening agents and/or activators, oxidizing agents, solubility modifiers, dispersants, rinse aids, metal protecting agents, stabilizing agents, corrosion inhibitors, sequestrants and/or chelating agents, builders, fragrances and/or dyes, humectants, rheology modifiers or thickeners, hardening agents, solidification agents, hydrotropes or couplers, buffers, solvents, pH buffers, cleaning enzymes, carriers, processing aids, solvents for liquid formulations, or others, and the like.

In an exemplary embodiment, a solid cleaning and/or rinse aid composition comprises from about 10 wt-% to about 80 wt-% of the solid polymer surfactant system, from about 10 wt-% to about 80 wt-% solidification aid, from about 0 wt-% to about 10 wt-% water conditioning agent, from about 0 wt-% to about 10 wt-% chelant, from about 0 wt-% to about 20 wt-% acidulant, from about 0 wt-% to about 5 wt-% water, and from about 0 wt-% to about 2 wt-% preservative and/or dye.

In a further exemplary embodiment of a solid cleaning and/or rinse aid composition comprises from about 10 wt-% to about 65 wt-% of the solid polymer surfactant system, from about 20 wt-% to about 60 wt-% solidification aid, from about 0 wt-% to about 8 wt-% water conditioning agent, from about 0 wt-% to about 5 wt-% chelant, from about 0 wt-% to about 15 wt-% acidulant, from about 0 wt-% to about 5 wt-% water, and from about 0 wt-% to about 2 wt-% preservative and/or dye.

In a still further exemplary embodiment of a solid cleaning and/or rinse aid composition comprises from about 5 wt-% to about 30 wt-% of the solid polymer surfactant system, from about 25 wt-% to about 65 wt-% solidification aid, from about 0 wt-% to about 5 wt-% water conditioning agent, from about 0 wt-% to about 3 wt-% chelant, from about 0 wt-% to about 10 wt-% acidulant, from about 0 wt-% to about 5 wt-% water, and from about 0 wt-% to about 2 wt-% preservative and/or dye.

In a still further exemplary embodiment, a solid cleaning and/or rinse aid composition comprises from about 20 wt-% to about 50 wt-% of the solid polymer surfactant system, from about 20 wt-% to about 80 wt-% solidification aid, from about 5 wt-% to about 10 wt-% water conditioning agent, from about 1 wt-% to about 10 wt-% chelant, from about 5 wt-% to about 20 wt-% acidulant, from about 0 wt-% to about 10 wt-% alkalinity source, from about 0 wt-% to about 2 wt-% antimicrobial agent, and from about 0 wt-% to about 2 wt-% preservative and/or dye.

In a still further exemplary embodiment, a solid cleaning and/or rinse aid composition comprises from about 20 wt-% to about 40 wt-% of the solid polymer surfactant system, from about 0 wt-% to about 10 wt-% additional nonionic surfactant and/or polymer, from about 40 wt-% to about 70 wt-% solidification aid, from about 0 wt-% to about 10 wt-% water conditioning agent, from about 5 wt-% to about 10 wt-% chelant, from about 5 wt-% to about 70 wt-% acidulant, from about 0 wt-% to about 2 wt-% antimicrobial agent, and from about 0 wt-% to about 2 wt-% preservative and/or dye.

In a still further exemplary embodiment, a solid cleaning and/or rinse aid composition comprises from about 20 wt-% to about 40 wt-% of the solid polymer surfactant system, from about 5 wt-% to about 30 wt-% additional nonionic surfactants and/or polymers (preferably at least two or at least three additional nonionic surfactants and/or polymers), from about 20 wt-% to about 60 wt-% solidification aid, from about 10 wt-% to about 50 wt-% acidulant, from about 0 wt-% to about 2 wt-% antimicrobial agent, and from about 0 wt-% to about 2 wt-% preservative and/or dye.

Hydrotropes

In some embodiments, the solid compositions can include a hydrotrope. The hydrotrope may be used to aid in maintaining the solubility of sheeting or wetting agents. Hydrotropes can also be used to modify the aqueous solution creating increased solubility for the organic material. In some embodiments, hydrotropes are low molecular weight aromatic sulfonate materials such as xylene sulfonates, dialkyldiphenyl oxide sulfonate materials, and cumene sulfonates.

A hydrotrope or combination of hydrotropes can be present in the solid compositions at an amount of from between about 1 wt % to about 50 wt %. In other embodiments, a hydrotrope or combination of hydrotropes can be present at about 10 wt % to about 30 wt % of the composition.

Hardening/Solidification Agents/Fillers

In some embodiments, the solid compositions can include a hardening agent (or a solidification agent or filler), as for example, an amide such stearic monoethanolamide or lauric diethanolamide, or an alkylamide, and the like; a solid polyethylene glycol, urea, or a solid EO/PO block copolymer, and the like; starches that have been made water-soluble through an acid or alkaline treatment process; various inorganics that impart solidifying properties to a heated composition upon cooling, and the like. Such compounds may also vary the solubility of the composition in an aqueous medium during use such that the wetting agent and/or other active ingredients may be dispensed from the solid composition over an extended period of time.

A solidification agent can be an organic or an inorganic hardening agent. Preferred solidification agents include polyethylene glycol (PEG) compounds. Examples of polyethylene glycols include, but are not limited to: solid polyethylene glycols of the general formula H(OCH₂CH₂)ₙOH, where n is greater than 15, particularly approximately 30 to approximately 1700 having a variety of molecular weights. Another preferred solidification agent is urea and/or urea particles. A still further preferred solidification agent is a sulfate compound, such as sodium sulfate and/or magnesium sulfate. Without being limited to a particular mechanism, the use of sulfates allows formulations with decreased SXS or other short chain alkyl benzene and/or alkyl naphthalene sulfonates.

In some embodiments, a solidification agent includes a short chain alkyl benzene and/or alkyl naphthalene sulfonate, preferably sodium xylene sulfonate (SXS). In some embodiments SXS is employed as a dual purpose material in that it acts as a coupler in solution but also as a solidifying agent as a powder.

A hardening agent or solidification agent can include one or more of sodium xylene sulfonate, sodium toluene sulfonate, sodium cumene sulfonate, potassium toluene sulfonate, ammonium xylene sulfonate, calcium xylene sulfonate, sodium alkyl naphthalene sulfonate, and sodium butylnaphthalene sulfonate. In an aspect of the invention, the class of short chain alkyl benzene or alkyl naphthalene hydrotropes includes alkyl benzene sulfonates based on toluene, xylene, and cumene, and alkyl naphthalene sulfonates. Sodium toluene sulfonate and sodium xylene sulfonate are the best known hydrotropes. In a preferred embodiment the solidification agent is SXS.

The compositions may include a solidification aid in an amount in the range of up to about 80 wt-%, from about 10 wt-% to about 80 wt-%, or up to about 50 wt-%. The compositions may include a solubility modifier in the range of about 20 wt-% to about 40 wt-%, or about 5 to about 15 wt-%.

Water Conditioning Agents

In some embodiments, the solid compositions can include a water conditioning agent. Carboxylates such as citrate, tartrate or gluconate are suitable. Water conditioning polymers can be used as non-phosphorus containing builders. Exemplary water conditioning polymers include, but are not limited to: polycarboxylates. Exemplary polycarboxylates that can be used as builders and/or water conditioning polymers include, but are not limited to: those having pendant carboxylate (—CO₂—) groups such as polyacrylic acid, maleic acid, maleic/olefin copolymer, sulfonated copolymer or terpolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, and hydrolyzed acrylonitrile-methacrylonitrile copolymers. For a further discussion of water conditioning agents, see Kirk-Othmer, Encyclopedia of Chemical Technology, Third Edition, volume 5, pages 339-366 and volume 23, pages 319-320, the disclosure of which is incorporated by reference herein. The solid compositions may include a water conditioning agent in an amount in the range of up to about 15 wt-%, up to about 10 wt-%, or up to about 5 wt-%.

Acidulants

In some embodiments, the solid compositions can include an acidulant or other pH buffer, and the like. The solid compositions can be formulated such that during use in aqueous operations, for example in aqueous cleaning operations, the rinse water will have a desired pH. For example, compositions designed for use in rinsing may be formulated such that during use in aqueous rinsing operation the rinse water will have a pH in the range of 8.5 or below, 8.3 or below, or 7 or below. In other aspects, the pH is about 3 to about 5, or in the range of about 5 to about 8.5. Liquid product formulations in some embodiments have a pH in the range of about 2 to about 4, or in the range of about 4 to about 9. Techniques for controlling pH at recommended usage levels include the use of buffers, alkali, acids, etc., and are well known to those skilled in the art. One example of a suitable acid for controlling pH includes citric acid, hydrochloric acid, phosphoric acid, sodium bicarbonate, protonated forms of phosphonates, sodium benzoate and gluconic acid. The solid compositions may include an acidulant water in an amount in the range of up to about 20 wt-%, up to about 15 wt-%, up to about 10 wt-%, or up to about 5 wt-%.

Chelating/Sequestering Agents

In some embodiments, the solid compositions can include one or more chelating/sequestering agents, which may also be referred to as a builder. A chelating/sequestering agent may include, for example an aminocarboxylic acid, aminocarboxylates and their derivatives, a condensed phosphate, a phosphonate, a polyacrylate, and mixtures and derivatives thereof. In general, a chelating agent is a molecule capable of coordinating (i.e., binding) the metal ions commonly found in natural water to prevent the metal ions from interfering with the action of the other ingredients of a wetting agent or other cleaning composition. The chelating/sequestering agent may also function as a threshold agent when included in an effective amount.

The composition may include a phosphonate such as 1-hydroxyethane-1,1-diphosphonic acid CH₃C(OH)[PO(OH)₂]₂; aminotri(methylenephosphonic acid) N[CH₂PO(OH)₂]₃; aminotri(methylenephosphonate), sodium salt; 2-hydroxyethyliminobis(methylenephosphonic acid) HOCH₂ CH₂ N[CH₂PO(OH)₂]₂; diethylenetriaminepenta(methylenephosphonic acid) (HO)₂POCH₂N[CH₂N[CH₂PO(OH)₂]₂]₂; diethylenetriaminepenta(methylenephosphonate), sodium salt C₉H₍₂₈₋ₓ₎N₃NaₓO₁₅P₅ (x=7); hexamethylenediamine(tetramethylenephosphonate), potassium salt C₁₀H₍₂₈₋ₓ₎N₂KₓO₁₂P₄ (x=6); bis(hexamethylene)triamine(pentamethylenephosphonic acid) (HO₂)POCH₂N[(CH₂)₆N[(CH₂PO(OH)₂]₂]₂; and phosphorus acid H₃PO₃. In some embodiments, a phosphonate combination such as ATMP and DTPMP may be used. A neutralized or alkaline phosphonate, or a combination of the phosphonate with an alkali source prior to being added into the mixture such that there is little or no heat or gas generated by a neutralization reaction when the phosphonate is added can be used. Some examples of polymeric polycarboxylates suitable for use as sequestering agents include those having a pendant carboxylate (—CO₂) groups and include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like.

The composition may include an aminocarboxylate or its derivatives, including for example sodium aminocarboxylate under the tradename Trilon A® available from BASF. A biodegradable aminocarboxylate or derivative thereof may also be included in the composition, including for example those available under the tradename Trilon available from BASF.

In some embodiments, the solid compositions can include in the range of up to about 70 wt-%, or in the range of about 0.1 to about 60 wt-%, or about 0.1 to about 5.0 wt-%, of a chelating/sequestering agent. In some embodiments, the solid compositions of the invention include less than about 1.0 wt-%, or less than about 0.5 wt-% of a chelating/sequestering agent. In other embodiments the solid compositions may include a chelant/sequestering agent in an amount in the range of up to about 10 wt-%, or up to about 5 wt-%.

Anti-Microbial/Sanitizing Agents

In some embodiments, the solid compositions can include an antimicrobial agent. The antimicrobial agent can be provided in a variety of ways. For example, in some embodiments, the antimicrobial agent is included as part of the wetting agent composition. In other embodiments, the antimicrobial agent can be included as a separate component of a composition including the wetting agent composition.

Antimicrobial agents are chemical compositions that can be used in a functional material to prevent microbial contamination and deterioration of material systems, surfaces, etc. Generally, these materials fall in specific classes including phenolics, halogen compounds, quaternary ammonium compounds, metal derivatives, amines, alkanol amines, nitro derivatives, analides, organosulfur and sulfur-nitrogen compounds and miscellaneous compounds.

In some embodiments, antimicrobial agents suitable for use with the solid compositions may include percarboxylic acid compositions or peroxygen compounds, and/or mixtures of diesters. For example, in some embodiments the antimicrobial agent included is at least one of peracetic acid, peroctanoic acid, and mixtures and derivatives thereof. In other embodiments, the sanitizing and/or antimicrobial agent may be a two solvent antimicrobial composition such as the composition disclosed in U.S. Pat. No. 6,927,237, the entire contents of which are hereby incorporated by reference.

In other embodiments, the sanitizing and/or antimicrobial agent may include compositions of mono- or diester dicarboxylates. Suitable mono- or diester dicarboxylates include mono- or dimethyl, mono- or diethyl, mono- or dipropyl (n- or iso), or mono- or dibutyl esters (n-, sec, or tert), or amyl esters (n-, sec-, iso-, or tert-) of malonic, succinic, glutaric, adipic, or sebacic acids, or mixtures thereof. Mixed esters (e.g., monomethyl/monoethyl, or monopropyl/monoethyl) can also be employed. Preferred mono- or diester dicarboxylates are commercially available and soluble in water or another carrier at concentrations effective for antimicrobial activity. Preferred mono- or diester dicarboxylates are toxic to microbes but do not exhibit unacceptable toxicity to humans under formulation or use conditions. Exemplary compositions including mono- or diester dicarboxylates are disclosed in U.S. Pat. No. 7,060,301, the entire contents of which are hereby incorporated by reference.

Some examples of common sanitizing and/or antimicrobial agents include phenolic antimicrobials such as pentachlorophenol, orthophenylphenol, a chloro-p-benzylphenol, p-chloro-m-xylenol. Halogen containing antibacterial agents include sodium trichloroisocyanurate, sodium dichloro isocyanate (anhydrous or dihydrate), iodine-poly(vinylpyrolidinone) complexes, bromine compounds such as 2-bromo-2-nitropropane-1,3-diol, and quaternary antimicrobial agents such as benzalkonium chloride, didecyldimethyl ammonium chloride, choline diiodochloride, tetramethyl phosphonium tribromide. Other antimicrobial compositions such as hexahydro-1,3,5-tris(2-hydroxyethyl)-s-triazine, dithiocarbamates such as sodium dimethyldithiocarbamate, and a variety of other materials are known in the art for their antimicrobial properties. In some embodiments, the rinse aid compositions are dosed in combination with a sanitizing agent (such as for low temperature applications of use) or further comprise sanitizing agent in an amount effective to provide a desired level of sanitizing.

Additional examples of common sanitizing and/or antimicrobial agents include chlorine-containing compounds such as a chlorine, a hypochlorite, chloramines, of the like.

In some embodiments, an antimicrobial component, can be included in the range of up to about 75% by wt. of the composition, up to about 20 wt. %, in the range of about 1.0 wt % to about 20 wt %, in the range of about 5 wt % to about 10 wt %, in the range of about 0.01 to about 1.0 wt. %, or in the range of 0.05 to 0.05 wt % of the composition.

Bleaching Agents

In some embodiments, the solid compositions of the present invention can include a bleaching agent. Bleaching agents can be used for lightening or whitening a substrate, and can include bleaching compounds capable of liberating an active halogen species, such as Cl₂, Br₂, —OCl⁻ and/or —OBr⁻, or the like, under conditions typically encountered during the cleansing process. Suitable bleaching agents for use can include, for example, chlorine-containing compounds such as a chlorine, a hypochlorite, chloramines, of the like. Some examples of halogen-releasing compounds include the alkali metal dichloroisocyanurates, chlorinated trisodium phosphate, the alkali metal hypochlorites, monochloramine and dichloroamine, and the like. Encapsulated chlorine sources may also be used to enhance the stability of the chlorine source in the composition.

A bleaching agent may also include an agent containing or acting as a source of active oxygen. The active oxygen compound acts to provide a source of active oxygen, for example, may release active oxygen in aqueous solutions. An active oxygen compound can be inorganic or organic, or can be a mixture thereof. Some examples of active oxygen compound include peroxygen compounds, or peroxygen compound adducts. Some examples of active oxygen compounds or sources include hydrogen peroxide, perborates, sodium carbonate peroxyhydrate, phosphate peroxyhydrates, potassium permonosulfate, and sodium perborate mono and tetrahydrate, with and without activators such as tetraacetylethylene diamine, and the like. A wetting agent composition may include a minor but effective amount of a bleaching agent, for example, in some embodiments, in the range of up to about 10 wt-%, and in some embodiments, in the range of about 0.1 to about 6 wt-%.

Builders or Fillers

In some embodiments, the solid compositions can include a minor but effective amount of one or more of a filler which does not necessarily perform as a rinse and/or cleaning agent per se, but may cooperate with the surfactant systems to enhance the overall capacity of the composition. Some examples of suitable fillers may include sodium sulfate, sodium chloride, starch, sugars, C₁-C₁₀ alkylene glycols such as propylene glycol, and the like. In some embodiments, a filler can be included in an amount in the range of up to about 20 wt-%, and in some embodiments, in the range of about 1-15 wt-%.

Anti-Redeposition Agents

In some embodiments, the solid compositions can include an anti-redeposition agent capable of facilitating sustained suspension of soils in a rinse solution and preventing removed soils from being redeposited onto the substrate being rinsed. Some examples of suitable anti-redeposition agents can include fatty acid amides, fluorocarbon surfactants, complex phosphate esters, styrene maleic anhydride copolymers, and cellulosic derivatives such as hydroxyethyl cellulose, hydroxypropyl cellulose, and the like. A solid composition may include up to about 10 wt-%, and in some embodiments, in the range of about 1 to about 5 wt-%, of an anti-redeposition agent.

Dyes/Odorants

In some embodiments, the solid compositions can include dyes, odorants including perfumes, and other aesthetic enhancing agents. Dyes may be included to alter the appearance of the composition, as for example, FD&C Blue 1 (Sigma Chemical), FD&C Yellow 5 (Sigma Chemical), Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), and the like. Fragrances or perfumes that may be included in the compositions include, for example, terpenoids such as citronellol, aldehydes such as amyl cinnamaldehyde, a jasmine such as C1S-jasmine or jasmal, vanillin, and the like. In other embodiments the solid compositions may include a preservative and/or dye in an amount in the range of up to about 2 wt-%, or up to about 1 wt-%.

Humectant

The solid compositions can also optionally include one or more humectant. A humectant is a substance having an affinity for water. The humectant can be provided in an amount sufficient to aid in reducing the visibility of a film on the substrate surface. The visibility of a film on substrate surface is a particular concern when the rinse water contains in excess of 200 ppm total dissolved solids. Accordingly, in some embodiments, the humectant is provided in an amount sufficient to reduce the visibility of a film on a substrate surface when the rinse water contains in excess of 200 ppm total dissolved solids compared to a rinse agent composition not containing the humectant. The terms “water solids filming” or “filming” refer to the presence of a visible, continuous layer of matter on a substrate surface that gives the appearance that the substrate surface is not clean.

Some example humectants that can be used include those materials that contain greater than 5 wt. % water (based on dry humectant) equilibrated at 50% relative humidity and room temperature. Exemplary humectants that can be used include glycerin, propylene glycol, sorbitol, alkyl polyglycosides, polybetaine polysiloxanes, and mixtures thereof. In some embodiments, the wetting agent composition can include humectant in an amount in the range of up to about 75% based on the total composition, and in some embodiments, in the range of about 5 wt. % to about 75 wt. % based on the weight of the composition. In some embodiments, where humectant is present, the weight ratio of the humectant to the sheeting agent can be in the range of about 1:3 or greater, and in some embodiments, in the range of about 5:1 and about 1:3.

Use Solutions

The solid polymer surfactant system compositions may include concentrate compositions or may be diluted to form use compositions. In general, a concentrate refers to a composition that is intended to be diluted with water to provide a use solution that contacts an object to provide the desired cleaning, rinsing, or the like. The composition that contacts the articles to be washed can be referred to as a concentrate or a use composition (or use solution) dependent upon the formulation employed in methods according to the invention. In an aspect, the surfactant systems in a use solution preferably have a pH of 8.5 or below, 8.3 or below, or 7 or below.

A use solution may be prepared from the concentrate by diluting the concentrate with water at a dilution ratio that provides a use solution having desired detersive properties. The water that is used to dilute the concentrate to form the use composition can be referred to as water of dilution or a diluent, and can vary from one location to another. The typical dilution factor is between approximately 1 and approximately 10,000 but will depend on factors including water hardness, the amount of soil to be removed and the like. In an embodiment, the concentrate is diluted at a ratio of between about 1:10 and about 1:10,000 concentrate to water. Particularly, the concentrate is diluted at a ratio of between about 1:100 and about 1:5,000 concentrate to water. More particularly, the concentrate is diluted at a ratio of between about 1:250 and about 1:2,000 concentrate to water.

In an embodiment, the solid polymer surfactant system composition preferably provides efficacious rinsing at low use dilutions, i.e., require less volume to clean effectively. In an embodiment, the solid polymer surfactant system concentrate composition is efficacious at low actives, such that the composition provides at least substantially similar effects, and preferably improved effects, in comparison to conventional surfactant systems. In an aspect, a use solution of the solid polymer surfactant system composition has between about 1 ppm to about 125 ppm surfactant concentration, between about 1 ppm to about 100 ppm surfactant concentration, between about 1 ppm to about 75 ppm surfactant concentration, between about 1 ppm to about 50 ppm surfactant concentration, and preferably between about 10 ppm to about 50 ppm surfactant concentration. In addition, without being limited according to the invention, all ranges recited are inclusive of the numbers defining the range and include each integer within the defined range.

Solid Compositions

Various solid compositions can be formulated using the solid polymer surfactant systems, including granular, flaked, prilled and pelletized solid compositions, powders, pressed solid block compositions, cast solid block compositions, extruded solid block composition and others. By the term “solid”, it is meant that the hardened composition will not flow and will substantially retain its shape under moderate stress or pressure or mere gravity. A solid may be in various forms such as a powder, a flake, a granule, a pellet, a tablet, a lozenge, a puck, a briquette, a brick, a solid block, a unit dose, or another solid form known to those of skill in the art. The degree of hardness of the solid cast composition and/or a pressed solid composition may range from that of a fused solid product which is relatively dense and hard, for example, like concrete, to a consistency characterized as being a hardened paste. In addition, the term “solid” refers to the state of the composition under the expected conditions of storage and use of the solid composition. In general, it is expected that the detergent composition will remain in solid form when exposed to temperatures of up to approximately 100° F. and particularly up to approximately 120° F.

The resulting solid composition may take forms including, but not limited to: a cast solid product; an extruded, molded or formed solid pellet, block, tablet, powder, granule, flake; pressed solid; or the formed solid can thereafter be ground or formed into a powder, granule, or flake. In an exemplary embodiment, extruded pellet materials formed by the solidification matrix have a weight of between approximately 50 grams and approximately 250 grams, extruded solids formed by the composition have a weight of approximately 100 grams or greater, and solid block detergents formed by the composition have a mass of between approximately 1 and approximately 10 kilograms. The solid compositions provide for a stabilized source of functional materials. In some embodiments, the solid composition may be dissolved, for example, in an aqueous or other medium, to create a concentrated and/or use solution. The solution may be directed to a storage reservoir for later use and/or dilution, or may be applied directly to a point of use.

Solid particulate materials can be made by merely blending the dry solid ingredients in appropriate ratios or agglomerating the materials in appropriate agglomeration systems. Pelletized materials can be manufactured by compressing the solid granular or agglomerated materials in appropriate pelletizing equipment to result in appropriately sized pelletized materials. Solid block and cast solid block materials can be made by introducing into a container either a prehardened block of material or a castable liquid that hardens into a solid block within a container. Preferred containers include disposable plastic containers or water soluble film containers. Other suitable packaging for the composition includes flexible bags, packets, shrink wrap, and water soluble film such as polyvinyl alcohol.

Various solid compositions may be formed using a batch or continuous mixing system. In an exemplary embodiment, a single- or twin-screw extruder is used to combine and mix one or more components at high shear to form a homogeneous mixture. In some embodiments, the processing temperature is at or below the melting temperature of the components. The processed mixture may be dispensed from the mixer by forming, casting or other suitable means, whereupon the composition hardens to a solid form. The structure of the matrix may be characterized according to its hardness, melting point, material distribution, crystal structure, and other like properties according to known methods in the art. Generally, a solid composition processed according to the methods herein are substantially homogeneous with regard to the distribution of ingredients throughout its mass and is dimensionally stable.

In an extrusion process, the liquid and solid components are introduced into final mixing system and are continuously mixed until the components form a substantially homogeneous semi-solid mixture in which the components are distributed throughout its mass. The mixture is then discharged from the mixing system into, or through, a die or other shaping means. The product is then packaged. In an exemplary embodiment, the formed composition begins to harden to a solid form in between approximately 1 minute and approximately 3 hours. Particularly, the formed composition begins to harden to a solid form in between approximately 1 minute and approximately 2 hours. More particularly, the formed composition begins to harden to a solid form in between approximately 1 minute and approximately 20 minutes.

In a casting process, the liquid and solid components are introduced into the final mixing system and are continuously mixed until the components form a substantially homogeneous liquid mixture in which the components are distributed throughout its mass. In an exemplary embodiment, the components are mixed in the mixing system for at least approximately 60 seconds. Once the mixing is complete, the product is transferred to a packaging container where solidification takes place. In an exemplary embodiment, the cast composition begins to harden to a solid form in between approximately 1 minute and approximately 3 hours. Particularly, the cast composition begins to harden to a solid form in between approximately 1 minute and approximately 2 hours. More particularly, the cast composition begins to harden to a solid form in between approximately 1 minute and approximately 20 minutes.

In a pressed solid process, a flowable solid, such as granular solids or other particle solids including the solid polymer surfactant systems are combined under pressure with other composition components. The solid polymer surfactant systems are particularly well suited for use in pressed solid compositions due to the lower liquid amounts to be included as a result of the synergy afforded by the formulation of the solid polymer surfactant systems requiring lower actives (i.e. less surfactant). According to a non-limiting example, a pressed solid according to the solid polymer surfactant systems and solid compositions employing the same include substantially less liquid (e.g. less than 30%, 10-30%, less than 20%, 10-20%, 5-20%, less than 15%, less than 12%, less than 10%, 5-10%, or less than 5%) in comparison to a conventional block solid would require between about 50-70% liquid.

In a pressed solid process, flowable solids of the compositions are placed into a form (e.g., a mold or container). The method can include gently pressing the flowable solid in the form to produce the solid cleaning composition. Pressure may be applied by a block machine or a turntable press, or the like. Pressure may be applied at about 1 to about 2000 psi, about 1 to about 300 psi, about 5 psi to about 200 psi, or about 10 psi to about 100 psi. In certain embodiments, the methods can employ pressures as low as greater than or equal to about 1 psi, greater than or equal to about 2, greater than or equal to about 5 psi, or greater than or equal to about 10 psi. As used herein, the term “psi” or “pounds per square inch” refers to the actual pressure applied to the flowable solid being pressed and does not refer to the gauge or hydraulic pressure measured at a point in the apparatus doing the pressing. The method can optionally include a curing step to produce the solid cleaning composition. As referred to herein, an uncured composition including the flowable solid is compressed to provide sufficient surface contact between particles making up the flowable solid that the uncured composition will solidify into a stable solid cleaning composition. A sufficient quantity of particles (e.g., granules) in contact with one another provides binding of particles to one another effective for making a stable solid composition. Inclusion of a curing step may include allowing the pressed solid to solidify for a period of time, such as a few hours, or about 1 day (or longer). In additional aspects, the methods could include vibrating the flowable solid in the form or mold, such as the methods disclosed in U.S. Pat. No. 8,889,048, which is herein incorporated by reference in its entirety.

The use of pressed solids provides numerous benefits over conventional solid block or tablet compositions requiring high pressure in a tablet press, or casting requiring the melting of a composition consuming significant amounts of energy, and/or by extrusion requiring expensive equipment and advanced technical know-how. Pressed solids overcome such various limitations of other solid formulations for which there is a need for making solid cleaning compositions. Moreover, pressed solid compositions retain its shape under conditions in which the composition may be stored or handled.

The following patents disclose various combinations of solidification, binding and/or hardening agents that can be utilized in the solid cleaning compositions of the present invention. The following U.S. patents are incorporated herein by reference: U.S. Pat. Nos. 7,153,820; 7,094,746; 7,087,569; 7,037,886; 6,831,054; 6,730,653; 6,660,707; 6,653,266; 6,583,094; 6,410,495; 6,258,765; 6,177,392; 6,156,715; 5,858,299; 5,316,688; 5,234,615; 5,198,198; 5,078,301; 4,595,520; 4,680,134; RE32,763; and RE32818.

Methods of Use

The solid polymer surfactant systems and compositions employing the same can be used for a variety of domestic/consumer applications as well as industrial applications. The compositions can be applied in a variety of areas including kitchens, bathrooms, factories, hospitals, dental offices, pharmaceutical plants or co-packers, and food plants or co-packers, and can be applied to a variety of hard or soft surfaces having smooth, irregular or porous topography. Suitable hard surfaces include, for example, architectural surfaces (e.g., floors, walls, windows, sinks, tables, counters and signs); eating utensils; hard-surface medical or surgical instruments and devices; and hard-surface packaging. Such hard surfaces can be made from a variety of materials including, for example, ceramic, metal, glass, wood or hard plastic. Suitable soft surfaces include, for example paper, filter media, hospital and surgical linens and garments, soft-surface medical or surgical instruments and devices, and soft-surface packaging. Such soft surfaces can be made from a variety of materials including, for example, paper, fiber, woven or nonwoven fabric, soft plastics and elastomers.

The methods of using the solid compositions can further include a method of dispensing a solid cleaning and/or rinse aid composition comprising: providing the solid cleaning and/or rinse aid compositions disclosed herein and generating a use solution by contacting with an aqueous source; and thereafter dispensing the use solution to an application of use in need of a cleaning and/or rinse aid composition. In an embodiment, the methods of dispensing provide a use solution comprising less than about 125 ppm active surfactant concentration. In some embodiments, the dispensing is from either an integrated or stand-alone solid product dispenser, wherein the use solution flows out of the dispenser. In other embodiments, the dispensing comprises direct placement of the solid cleaning and/or rinse aid composition into a vessel or apparatus without the use of a dispenser to generate the use solution.

The solid polymer surfactant systems and compositions employing the same of the invention can be used in a variety of applications, including for example, a ware wash application, laundry application and/or hard surface application. For example, in some embodiments, the solid polymer surfactant systems and compositions can be formulated for use in warewashing applications, including rinse cycles in commercial warewashing machines. A first type of rinse cycle can be referred to as a hot water sanitizing rinse cycle because of the use of generally hot rinse water (about 180° F.). A second type of rinse cycle can be referred to as a chemical sanitizing rinse cycle and it uses generally lower temperature rinse water (about 120° F.). Beneficially, the solid polymer surfactant systems and compositions employing the same are particularly well suited for use in both low and high temperature conditions.

The methods of employing the solid polymer surfactant systems and compositions employing the surfactant systems are particularly suited for use in closed systems, e.g. dish or ware washing systems for obtaining enhanced sheeting, wetting and drying on articles and surfaces. According to embodiments the solid polymer surfactant systems and compositions employing them are suitable for both low temperature and high temperature applications. As referred to herein, low temperature ware wash includes was temperatures at or below about 140° F. In an embodiment, the temperature of the rinse water is up to about 140° F., preferably in the range of 100° F. to 140° F., preferably in the range of 110° F. to 140° F., and most preferably in the range of 120° F. to 140° F. As referred to herein, “low temperature” refers to those rinse water temperatures below about 140° F. In an aspect, the methods of the invention employing a low temperature further employ a sanitizer.

As referred to herein, high temperature (or sanitizing) rinse includes temperatures above about 140° F. In an aspect, high temperature refers to a rinse temperature for ware washing above 140° F., or from about 140° F. to about 190° F., or from about 145° F. to about 180° F.

The solid polymer surfactant systems and compositions employing them can contact the surface or article by numerous methods for applying a composition, such as spraying the composition, immersing the object in the composition, or a combination thereof. A concentrate or use concentration of a composition can be applied to or brought into contact with an article by any conventional method or apparatus for applying a cleaning composition to an object. For example, the object can be wiped with, sprayed with, and/or immersed in the composition, or a use solution made from the composition. The composition can be sprayed, or wiped onto a surface; the composition can be caused to flow over the surface, or the surface can be dipped into the composition. Contacting can be manual or by machine.

Exemplary articles in the warewashing industry that can be treated with the solid compositions include plastics, dishware, cups, glasses, flatware, and cookware. For the purposes of this invention, the terms “dish” and “ware” are used in the broadest sense to refer to various types of articles used in the preparation, serving, consumption, and disposal of food stuffs including pots, pans, trays, pitchers, bowls, plates, saucers, cups, glasses, forks, knives, spoons, spatulas, and other glass, metal, ceramic, plastic composite articles commonly available in the institutional or household kitchen or dining room. In general, these types of articles can be referred to as food or beverage contacting articles because they have surfaces which are provided for contacting food and/or beverage. When used in these warewashing applications, the solid polymer surfactant systems provide effective sheeting action, low foaming properties and fast drying. In some aspects, the solid polymer surfactant system and compositions employing the same dries a surface (e.g. ware) within about 30 seconds to a few minutes, or within about 30 to about 90 seconds after the aqueous solution is applied.

In addition to having the desirable properties described above, it may also be useful for the solid polymer surfactant systems and compositions employing the same to be biodegradable, environmentally friendly, and generally nontoxic. A wetting agent of this type may be described as being “food grade”.

The solid polymer surfactant systems and compositions employing the same may also be applied to surfaces and objects other than ware, including, but not limited to, medical and dental instruments, and hard surfaces such as vehicle surfaces or any other facility surfaces, textiles and laundry, use in mining and/or other industrial energy services. The compositions may also be used as rinse aids in a variety of applications for a variety of surfaces, e.g., included in compositions used to sanitize, disinfect, act as a sporicide for, or sterilize bottles, pumps, lines, tanks and mixing equipment used in the manufacture of such beverages. Still further, the solid polymer surfactant systems and compositions employing the same are particularly suitable for use as rinse aids, including glass cleaners. These are other applications of use are included within the scope of the present invention.

All publications and patent applications in this specification are indicative of the level of ordinary skill in the art to which this invention pertains. All publications and patent applications are herein incorporated by reference to the same extent as if each individual publication or patent application was specifically and individually indicated as incorporated by reference.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1

The polymer surfactants of the solid copolymer surfactant system were tested for wetting and sheeting performance and compared to performance of the polymer and surfactant added separately to a composition to demonstrate the improved performance of the copolymer surfactant.

Sheeting Efficacy. This test involves observation of water sheeting on eleven different types of ware wash materials. The materials used for the evaluation are a 10 oz. glass tumbler, a china dinner plate, a melamine dinner plate, a polypropylene coffee cup, a dinex bowl, a polypropylene jug, a polysulfonate dish, a stainless steel butter knife, a polypropylene café tray, a fiberglass café tray and a stainless steel slide 316. These test materials are meticulously cleaned and then soiled with a solution containing a 0.2% Hotpoint soil which is a mixture of powder milk and margarine. The materials are then exposed to 30 second wash cycles using 160° F. soft water (for high temperature evaluations) or 120° and 140° F. soft water (for low temperature evaluations); the evaluated temperatures are shown in the tables below. The test product is measured in parts per million actives surfactant (tested from 10 ppm to 190 ppm; testing beyond this active level is considered inefficient when the invention is directed to finding efficient polymer surfactant systems and such concentrations would not be desirable). The active (ppm) is based on the surfactant concentrations and does not include the polymer concentration in the evaluated surfactant systems. Immediately after the ware wash materials are exposed to the test product the appearance of the water draining off of the individual test materials (sheeting) is examined.

Immediately after the ware wash materials were exposed to the surfactants or solid surfactant polymers, the appearance of the water draining off of the individual ware wash materials (sheeting) was examined and evaluated. The sheeting evaluation is based on the following scale: “- - -” (0) signifying no sheeting, the number “one” (1) signifying pin hole sheeting, or the letter “X” (2) signifying complete sheeting. Pinhole sheeting refers to the appearance of tiny pinholes on the surface of the water, as the water is draining off of the washed article. These holes increase slightly in size as the water continues to drain off the ware. Complete sheeting refers to a continuous sheet of water on the washed article as the water drains off the ware. The test was complete when all of the washed articles display complete sheeting.

The foam level in the machine is also noted. Stable foam at any level is unacceptable. Foam that is less then ½ inch that breaks to nothing as soon as the machine is shut off is acceptable and no foam is best.

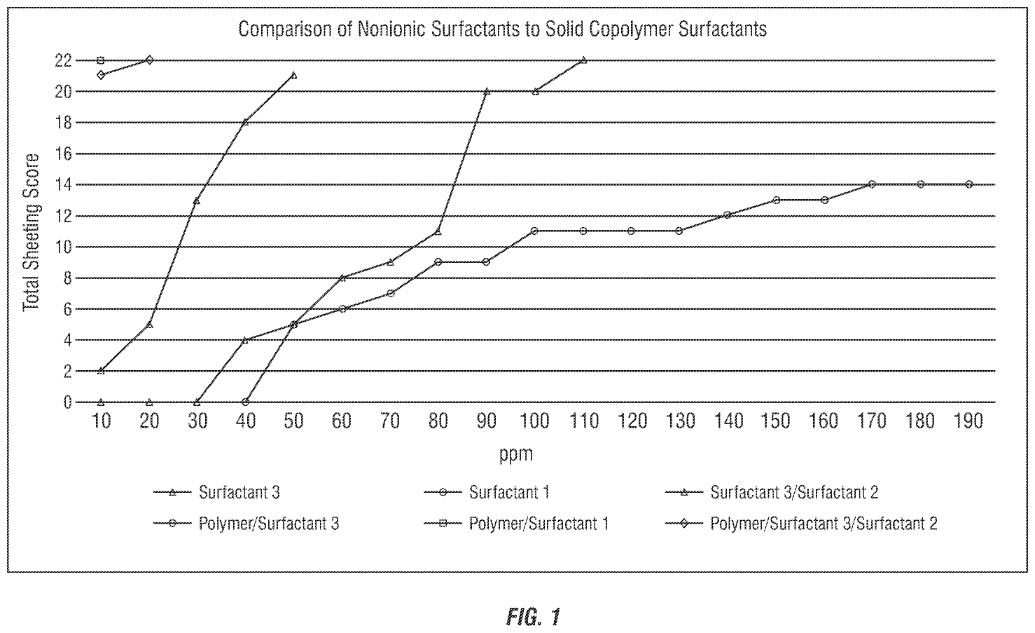

The sheeting data is shown individually in Tables 6-11 and also cumulatively in FIG. 1 and clearly shows that the individual nonionic surfactants alone fail to wet out and sheet as fast as the solid polymer surfactants (containing the nonionic surfactant).

TABLE 6
(Surfactant 3)

| ppm, Actives in Rinse Aid | 40 | 50 | 60 | 70 | 80 | 90 | 100 | 110 |
|---|---|---|---|---|---|---|---|---|
| Glass tumbler | — | — | — | 1 | 1 | X | X | X |
| China Plate | 1 | 1 | 1 | 1 | X | X | X | X |
| Melamine Plate | 1 | 1 | 1 | 1 | X | X | X | X |
| Polypropylene Cup | — | — | — | — | — | 1 | 1 | X |
| Dinex Bowl | — | — | — | — | — | 1 | 1 | X |
| Polypropylene Jug | — | — | 1 | 1 | 1 | X | X | X |
| Polysulfonate Dish | — | — | 1 | 1 | 1 | X | X | X |
| Stainless Steel Knife | — | 1 | 1 | 1 | 1 | X | X | X |
| Polypropylene tray | 1 | 1 | 1 | 1 | 1 | X | X | X |
| Fiberglass tray | — | — | 1 | 1 | 1 | X | X | X |
| Stainless steel slide 316 | 1 | 1 | 1 | 1 | 1 | X | X | X |
| Temperature, ° F. | 157 | 157 | 157 | 157 | 157 | 157 | 157 | 157 |
| Suds | None | None | None | None | None | None | None | None |

TABLE 7
(Polyphosphinoacrylic acid/Surfactant 3 Complex)

| ppm, Actives in Rinse Aid | 10 |
|---|---|
| Glass tumbler | X |
| China Plate | X |
| Melamine Plate | X |
| Polypropylene Cup | X |
| Dinex Bowl | X |
| Polypropylene Jug | X |
| Polysulfonate Dish | X |
| Stainless Steel Knife | X |
| Polypropylene tray | X |
| Fiberglass tray | X |
| Stainless steel slide 316 | X |
| Temperature, ° F. | 160 |
| Suds | 0.5″ |

TABLE 8-A
(Surfactant 1)

| ppm, Actives in Rinse Aid | 40 | 50 | 60 | 70 | 80 | 90 | 100 | 110 | 120 |
|---|---|---|---|---|---|---|---|---|---|
| Glass tumbler | — | — | — | — | — | — | 1 | 1 | 1 |
| China Plate | — | — | — | 1 | 1 | 1 | 1 | 1 | 1 |
| Melamine Plate | — | 1 | 1 | 1 | 1 | 1 | 1 | 1 | 1 |
| Polypropylene Cup | — | — | — | — | 1 | 1 | 1 | 1 | 1 |
| Dinex Bowl | — | — | 1 | 1 | 1 | 1 | 1 | 1 | 1 |
| Polypropylene Jug | — | 1 | 1 | 1 | 1 | 1 | 1 | 1 | 1 |
| Polysulfonate Dish | — | — | — | — | 1 | 1 | 1 | 1 | 1 |
| Stainless Steel Knife | — | 1 | 1 | 1 | 1 | 1 | 1 | 1 | 1 |
| Polypropylene tray | — | 1 | 1 | 1 | 1 | 1 | 1 | 1 | 1 |
| Fiberglass tray | — | — | — | — | — | — | 1 | 1 | 1 |
| Stainless steel slide 316 | — | 1 | 1 | 1 | 1 | 1 | 1 | 1 | 1 |
| Temperature, ° F. | 157 | 157 | 157 | 157 | 157 | 157 | 157 | 157 | 157 |
| Suds | None | None | None | None | None | None | None | None | None |

TABLE 8-B
(Surfactant 1)

| ppm, Actives in Rinse Aid | 130 | 140 | 150 | 160 | 170 | 180 | 190 |
|---|---|---|---|---|---|---|---|
| Glass tumbler | 1 | 1 | 1 | 1 | 1 | 1 | 1 |
| China Plate | 1 | 1 | 1 | 1 | 1 | 1 | 1 |
| Melamine Plate | 1 | 1 | 1 | 1 | 1 | 1 | 1 |
| Polypropylene Cup | 1 | 1 | 1 | 1 | 1 | 1 | 1 |
| Dinex Bowl | 1 | 1 | 1 | 1 | X | X | X |
| Polypropylene Jug | 1 | 1 | X | X | X | X | X |
| Polysulfonate Dish | 1 | 1 | 1 | 1 | 1 | 1 | 1 |
| Stainless Steel Knife | 1 | 1 | 1 | 1 | 1 | 1 | 1 |
| Polypropylene tray | 1 | 1 | 1 | 1 | 1 | 1 | 1 |
| Fiberglass tray | 1 | X | X | X | X | X | X |
| Stainless steel slide 316 | 1 | 1 | 1 | 1 | 1 | 1 | 1 |
| Temperature, ° F. | 157 | 157 | 157 | 157 | 157 | 157 | 157 |
| Suds | None | None | None | None | None | None | None |

TABLE 9
(Polyphosphinoacrylic acid/Surfactant 1 complex)

| ppm, Actives POLYMER | 10 |
|---|---|
| Glass tumbler | X |
| China Plate | X |
| Melamine Plate | X |
| Polypropylene Cup | X |
| Dinex Bowl | X |
| Polypropylene Jug | X |
| Polysulfonate Dish | X |
| Stainless Steel Knife | X |
| Polypropylene tray | X |
| Fiberglass tray | X |
| Stainless steel slide 316 | X |
| Temperature, ° F. | 160 |
| Suds | None |

TABLE 10
(Surfactant 3/Surfactant 2- 50/50)

| ppm, Actives in Rinse Aid | 10 | 20 | 30 | 40 | 50 |
|---|---|---|---|---|---|
| Glass tumbler | — | — | — | 1 | X |
| China Plate | — | — | 1 | 1 | X |
| Melamine Plate | X | X | X | X | X |
| Polypropylene Cup | — | — | 1 | X | X |
| Dinex Bowl | — | 1 | X | X | X |
| Polypropylene Jug | — | 1 | X | X | X |
| Polysulfonate Dish | — | 1 | X | X | X |
| Stainless Steel Knife | — | — | 1 | X | X |
| Polypropylene tray | — | — | 1 | 1 | X |
| Fiberglass tray | — | — | — | 1 | X |
| Stainless steel slide 316 | — | — | 1 | X | X |
| Temperature, ° F. | 157 | 157 | 157 | 157 | 157 |

| | |
|---|---|
| Suds | 1/4″ foam |

TABLE 11
(Polyphosphinoacrylic acid w/Surfactant 3/Surfactant 2- 50/50)

| ppm, Actives in Rinse Aid | 10 | 20 |
|---|---|---|
| Glass tumbler | X | X |
| China Plate | X | X |
| Melamine Plate | X | X |
| Polypropylene Cup | X | X |
| Dinex Bowl | X | X |
| Polypropylene Jug | X | X |
| Polysulfonate Dish | X | X |
| Stainless Steel Knife | X | X |
| Polypropylene tray | X | X |
| Fiberglass tray | 1 | X |
| Stainless steel slide 316 | X | X |
| Temperature, ° F. | 161 | 160 |
| Suds | 1″ | 1″ |

FIG. 1 depicts sheeting curves where the faster (i.e. steeper curve) the total sheeting score achieves at least 20 or 22 the beneficial sheeting is achieved at a lower concentration as is desired. FIG. 1 shows the solid polymer surfactants Polyphosphinoacrylic acid (labeled as Polymer in figures)/Surfactant 1 has excellent sheeting wetting on the substrates where the 10 ppm concentration achieves the total sheeting scores of 22, and that the solid polymer surfactant Polyphosphinoacrylic acid/Surfactant 3/Surfactant 2 has excellent sheeting wetting on the substrates where the 10 ppm concentration achieves the total sheeting scores above 20 and the 20 ppm concentration achieves the score of 22. Based on the demonstrated efficacy of the various solid polymer surfactants, additional sheeting testing was conducted with additional solid polymer surfactant systems.

### Example 2

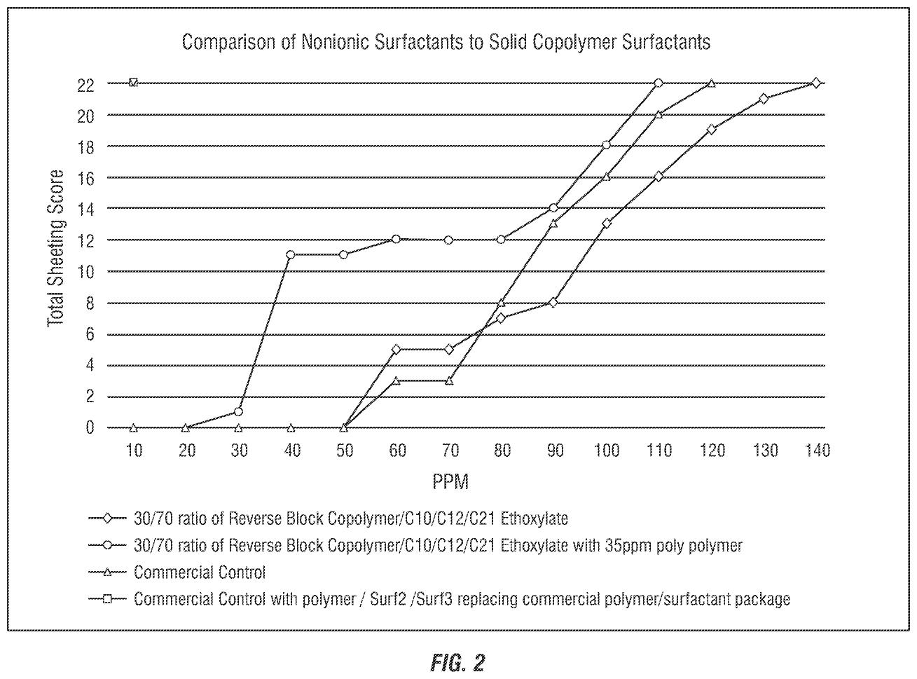

Additional sheeting tests were completed for additional polymer systems according to the methods of Example 1 to compare alternative surfactant/polymer systems. The sheeting data is shown individually in Tables 12-15 and also cumulatively in FIG. 2.

TABLE 12
(30/70 ratio of surfactant reverse block copolymer/C10/C12/C21 ethoxylate - no polymers)

| ppm, Actives in Rinse Aid | 40 | 50 | 60 | 70 | 80 | 90 | 100 | 110 | 120 | 130 | 140 |
|---|---|---|---|---|---|---|---|---|---|---|---|
| Polycarbonate Tile | — | — | — | — | — | — | — | — | 1 | 1 | X |
| Glass tumbler | — | — | 1 | 1 | 1 | 1 | X | X | X | X | X |
| China Plate | — | — | 1 | 1 | X | X | X | X | X | X | X |
| Melamine Plate | — | — | 1 | 1 | X | X | X | X | X | X | X |
| Polypropylene Cup | — | — | — | — | — | — | 1 | 1 | 1 | X | X |
| Dinex Bowl | — | — | — | — | — | — | — | 1 | 1 | X | X |
| Polypropylene Jug | — | — | — | — | — | — | — | 1 | X | X | X |
| Polysulfonate Dish | — | — | — | — | — | — | 1 | 1 | 1 | X | X |
| Stainless Steel Knife | — | — | 1 | 1 | 1 | 1 | X | X | X | X | X |
| Polypropylene tray | | | — | — | — | — | — | 1 | X | X | X |
| Fiberglass tray | — | — | — | — | — | — | 1 | 1 | X | X | X |
| Stainless steel slide 316 | — | — | 1 | 1 | 1 | X | X | X | X | X | X |
| Temperature, ° F. | 157 | 157 | 157 | 157 | 157 | 157 | 157 | 157 | 157 | 157 | 157 |
| Suds | none | none | none | none | none | none | none | none | none | none | none |

TABLE 13
(30/70 ratio of surfactant reverse block copolymer/C10/C12/C21
ethoxylate and 35 ppm polyacrylic acid polymer)

| ppm, Actives in Rinse Aid | 10 | 20 | 30 | 40 | 50 | 60 | 70 | 80 | 90 | 100 | 110 |
|---|---|---|---|---|---|---|---|---|---|---|---|
| Glass tumbler | — | — | 1 | 1 | 1 | X | X | X | X | X | X |
| China Plate | — | — | — | 1 | 1 | 1 | 1 | 1 | X | X | X |
| Melamine Plate | — | — | — | 1 | 1 | 1 | 1 | 1 | X | X | X |
| Polypropylene Cup | — | — | — | 1 | 1 | 1 | 1 | 1 | 1 | 1 | X |
| Dinex Bowl | — | — | — | 1 | 1 | 1 | 1 | 1 | 1 | X | X |
| Polypropylene Jug | — | — | — | 1 | 1 | 1 | 1 | 1 | 1 | X | X |
| Polysulfonate Dish | — | — | — | 1 | 1 | 1 | 1 | 1 | 1 | X | X |
| Stainless Steel Knife | — | — | — | 1 | 1 | 1 | 1 | 1 | 1 | X | X |
| Polypropylene tray | — | — | — | 1 | 1 | 1 | 1 | 1 | 1 | 1 | X |
| Fiberglass tray | — | — | — | 1 | 1 | 1 | 1 | 1 | 1 | 1 | X |
| Stainless steel slide 316 | — | — | — | 1 | 1 | 1 | 1 | 1 | 1 | 1 | X |
| Temperature, ° F. | 143 | 143 | 143 | 143 | 143 | 143 | 143 | 143 | 143 | 143 | 143 |

| | |
|---|---|
| Suds | No foam |

TABLE 14
(Commercial Control (full formula contains polyacrylic acid polymer))

| ppm, Actives in Rinse Aid | 40 | 50 | 60 | 70 | 80 | 90 | 100 | 110 | 120 |
|---|---|---|---|---|---|---|---|---|---|
| Glass tumbler | — | — | — | — | 1 | X | X | X | X |
| China Plate | — | — | — | — | X | X | X | X | X |
| Melamine Plate | — | — | 1 | 1 | X | X | X | X | X |
| Polypropylene Cup | — | — | — | — | — | — | — | 1 | X |
| (yellow) | | | | | | | | | |
| Dinex Bowl | — | — | — | — | — | — | 1 | X | X |
| Polypropylene Jug | — | — | — | — | — | 1 | X | X | X |
| Polysulfonate Dish | — | — | — | — | — | 1 | X | X | X |
| Stainless Steel Knife | — | — | 1 | 1 | X | X | X | X | X |
| Polypropylene tray | — | — | — | — | — | — | — | 1 | X |
| Fiberglass tray | — | — | — | — | — | 1 | 1 | X | X |
| Stainless steel slide 316 | — | — | 1 | 1 | 1 | X | X | X | X |
| Temperature, ° F. | 157 | 157 | 157 | 157 | 157 | 157 | 157 | 157 | 157 |
| Suds | none | none | none | none | none | none | none | none | none |

TABLE 15
(Polyphosphinoacrylic acid/Surfactant 2/Surfactant 3 in
Commercial Control (commercial polymer and surfactant
package was replaced with solid copolymer surfactant))

| ppm, Actives in Rinse Aid | 10 |
|---|---|
| Glass tumbler | X |
| China Plate | X |
| Melamine Plate | X |
| Polypropylene Cup | X |
| Dinex Bowl | X |
| Polypropylene Jug | X |
| Polysulfonate Dish | X |
| Stainless Steel Knife | X |
| Polypropylene tray | X |
| Fiberglass tray | X |
| Stainless steel slide 316 | X |
| Temperature, ° F. | 159 |
| Suds | 3 |

The sheeting graph shows the 30/70 reverse block copolymer surfactant/C10/C12/C21 ethoxylate combination of nonionic surfactants together and then in combination with the additional component that is in the solid copolymer surfactant (polyacrylic acid polymer) as you can see there is very little improvement in sheeting wetting when the raw materials are added separately to the solution versus when the solid copolymer surfactant is added to an existing inline commercial rinse aid formulation (Commercial Control). However, the solid polymer surfactant Polyphosphinoacrylic acid/Surfactant 2/Surfactant 3 (approximately 3:1 polymer surfactant) as compared to the component polymer and surfactant added in their natural forms in the Commercial Control are more efficient at sheeting and wetting out of the surfaces as both solid polymer surfactants have complete sheeting (score of 22) at 10 ppm versus the inline formulation where the raw materials were just added to solid components have a synergistic effect formed into the solid raw material versus added individually.

### Example 3

Glewwe Foam tests were also conducted on various surfactants compared to solid polymer surfactants. The following Tables 16A-D show several foam studies run on using the Glewwe foam apparatus. The foam profiles below show several of the raw materials by themselves and then in combination with each other. The raw material(s) was added to the circulating water, and the foam generated was measured after one minute and five minutes. The foam level is read after one minute of agitation and again after 5 minutes of agitation. Stable foam remains for several minutes after agitation is stopped. Partially stable foam breaks slowly within a minute. Unstable foam breaks rapidly, less the 15 seconds. The best results are unstable foam to no foam. Surfactants or solid polymer surfactants that produce excessive amounts of stable foam in this evaluation were identified as undesirable as they cause machine pump cavitation.

Tables 16A-16D show initial testing of surfactants and solid polymer surfactants for foaming. The foam profiles indicate how much foam is generated by each surfactant or solid polymer surfactant at different temperatures to give a better understanding of how it will foam in a dish machine, for example. The foam studies were completed using the Glewwe foam apparatus where foam level was read after one minute of agitation and again after 5 minutes of agitation. The Glewwe foam apparatus was set at 6 psi for 5 minutes at varied temperatures (° C.). The machine was then shut off and foam was measured for 1 minute. Test were run in soft water (3 L), used 20 g powdered milk and 50 ppm active surfactant (at 100% actives level). The initial 1 minute testing shows foaming with surfactant only; the soil challenge after 5 minutes included presence of 2000 ppm soil and measured foaming with surfactant in presence of soil (indicative of foam measurement wherein a desirable foam profile is less than 5 inches. 2% solutions were made for all testing in this Example.

TABLE 16 A

| | | after 1 min run time | | | after 5 (total) minutes | | |
|---|---|---|---|---|---|---|---|
| | Temp | (inches) | | | run time | | |
| Product | (° F.) | initial | 15 sec | 1 min | initial | 15 sec | 1 min |
| Surfactant 3 20.7% polyphosphinoacrylic acid | 140 | 2½ | ⅜ | ¼ | 8½ | 8 | 7¾ |
| 79.3% copolymer blend | | | | | | | |
| Surfactant 3 20.7% polyphosphinoacrylic acid | 140 | 2 | ⅜ | ¼ | 8 | 7¾ | 6¼ |
| 79.3% copolymer blend | | | | | | | |
| Surfactant 3 12.5% Surfactant 2 12.5% | 140 | 4¾ | 3¼ | 1 | 9½ | 9 | 8½ |
| polyphosphinoacrylic acid 75% copolymer | | | | | | | |
| Polyphosphinoacrylic acid/Surfactant 1 70/30 | 140 | 5½ | 5 | 4¾ | 8½ | 8½ | 8 |
| pH 4.42; additional surfactant added to the | | | | | | | |
| surfactant in the polyAA copolymer; | | | | | | | |
| [(polyAA/surf3/surf2)/surf1] | | | | | | | |
| (52.5/8.75/8.75)/30 | | | | | | | |
| Polyphosphinoacrylic acid/Surfactant 1 | 140 | 1¾ | ¾ | ⅜ | 6 | 4½ | 2 |
| 50/50; additional surfactant added to the | | | | | | | |
| surfactant in the polyAA copolymer; | | | | | | | |
| [(polyAA/surf 3/surf2)/surf1] | | | | | | | |
| (37.5/6.25/6.25)/50 | | | | | | | |
| Polyphosphinoacrylic acid/Surfactant 1 | 140 | 1½ | ½ | ¼ | 4½ | 2¼ | 1½ |
| 30/70; additional surfactant added to the | | | | | | | |
| surfactant in the polyAA copolymer; | | | | | | | |
| [(polyAA/surf3/surf2)/surf1] | | | | | | | |
| (22.5/3.75/3.75)/70 | | | | | | | |

TABLE 16 B

| | | after 1 min run time | | | after 5 (total) minutes | | |
|---|---|---|---|---|---|---|---|
| | Temp | (inches) | | | run time | | |
| Product | (° F.) | initial | 15 sec | 1 min | initial | 15 sec | 1 min |
| Surf 1 20% polyAA 80% copolymer blend | 140 | 6¾ | 5¼ | 2½ | 9 | 8¾ | 8½ |
| pH 5.79 | | | | | | | |
| Polyphosphinoacrylic acid/Surfactant 1 | 140 | 1¾ | ½ | ⅜ | 2 | ⅜ | ¼ |
| (30 copolymer/70 Surfactant 1); [(surf | | | | | | | |
| 1/polyAA)/surf 1] (24/6)/70 | | | | | | | |
| Surf 1 20% polyAA 80% copolymer blend | 140 | 5½ | 5 | 3½ | 9 | 8¾ | 8½ |
| pH 4.71 | | | | | | | |
| Polyphosphinoacrylic acid/Surfactant 1 | 140 | 2 | 1 | ½ | 2 | ⅜ | ¼ |

TABLE 16 C

| | | after 1 min run time | | | after 5 (total) minutes | | |
|---|---|---|---|---|---|---|---|
| | Temp | (inches) | | | run time | | |
| Product; [(surf 1/AA)/surf 1] (24/6)/70 | (° F.) | initial | 15 sec | 1 min | initial | 15 sec | 1 min |
| Acrylic Acid (60%)/Methacrylic Acid | 140 | 3 | 1½ | ½ | 8½ | 8¼ | 6¼ |
| (15%) with 25% Surfactant 1 | | | | | | | |
| (copolymer alone) | | | | | | | |
| Acylic Acid (60%)/Methacrylic Acid | 140 | 1 | ¼ | ⅛ | 2½ | ⅜ | ¼ |
| (15%)/Surfactant 1 (50 copolymer/50 | | | | | | | |
| Surfactant 1); 50% additional surf 1; | | | | | | | |
| 50 copolymer (30 AA/7.5 MAA/12.5 | | | | | | | |
| surf 1)/50 surf 1 | | | | | | | |
| Acylic Acid (60%)/Methacrylic Acid | 140 | 1 | ¼ | ⅛ | 2 | ¼ | ¼ |
| (15%)/Surfactant 1 (30 copolymer/70 | | | | | | | |
| Surfactant 1); 70% additional surf 1; | | | | | | | |
| 30 copolymer(18 AA/4.5 MAA/7.5 | | | | | | | |
| surf 1)/70 surf 1 | | | | | | | |
| Acylic Acid (48%)/Methacrylic Acid | 140 | 3 | 1½ | ½ | 8½ | 8 | 7 |
| (27%) with Surfactant 1 (25%) | | | | | | | |

TABLE 16 D

| | | after 1 min run time | | | after 5 (total) minutes | | |
|---|---|---|---|---|---|---|---|
| | Temp | (inches) | | | run time | | |
| Product | (° F.) | initial | 15 sec | 1 min | initial | 15 sec | 1 min |
| Polyphosphinoacrylic acid (82.8%) | 140 | 2¾ | ¾ | ¼ | 8 | 7 | 5½ |
| with 17.2% Surfactant 1 (copolymer | | | | | | | |
| alone) | | | | | | | |
| Polyphosphinoacrylic acid (82.8%) | 140 | ½ | ¼ | ¼ | 2 | ¼ | ¼ |
| with 17.2% Surfactant 1/Surfactant | | | | | | | |
| 1 (30 copolymer/70 Surfactant 1) | | | | | | | |
| Polyphosphinoacrylic acid (82.8%) | 140 | 3 | 1¼ | ½ | 8 | 7 | 5½ |
| with 17.2% Surfactant 1 | | | | | | | |
| Polyphosphinoacrylic acid (82.8%) | 140 | ½ | ¼ | ¼ | 2 | ¼ | ¼ |
| with 17.2% Surfactant 1/Surfactant 1 | | | | | | | |
| (30 copolymer/70 Surfactant 1) | | | | | | | |
| Polyphosphinoacrylic acid 80%/ | 140 | trace | 0 | 0 | 1¾ | ⅛ | ⅛ |
| Surfactant 1 20% | | | | | | | |
| Polyphosphinoacrylic acid 50%/ | 140 | trace | 0 | 0 | ½ | 0 | 0 |
| Surfactant 1 50% copolymer | | | | | | | |

The foam level in the machine was noted. In reference to the results shown in Table 19 above, the amount of foam in inches indicates how much foam remains, wherein a minimal amount is preferred after 1 minute and 15 minutes. Partially stable foam broke down slowly within a minute. Unstable foam broke rapidly, within less the 15 seconds. The best results were unstable foam or no foam, as generally, stable foam at any level is unacceptable for rinse aid applications. Foam that is less than one half of an inch and that is unstable and breaks to nothing soon after the machine is shut off is acceptable, but no foam is best. Various solid polymer surfactants demonstrated beneficial low- or no-foam profiles under the testing conditions. This is particularly beneficial for pressed solid applications where defoamer, such as a defoaming surfactant, is preferred for the pressed formulations to avoid adding additional liquid content to the pressed formulations.

### Example 4

50 cycle redeposition, 50 cycle film, and100 cycle film evaluations were performed for the formulations in Table 17. After performing sheeting and foam evaluations in Examples 1-3 some of the solid polymer surfactants were evaluated for redeposition and film in a ware washing test. In the 50 cycle redeposition evaluation 3 controls were used. The detergent alone (Negative Control), along with two inline formulations (Negative Control with no builder; Positive Control with Nonionic Surfactants commercially available).

TABLE 17

| Formulation | 1 | 2 | 3 | 4 | 5 | 6 | 7 | 8 | 9 | 10 | 11 | 12 | 13 | 14 |
|---|---|---|---|---|---|---|---|---|---|---|---|---|---|---|
| SXS 96% | 75 | 69 | 57 | 57 | 57 | 57 | 57 | 65 | 85 | 70 | 65 | 65 | 60 | 70 |
| Surfactant 3 | 6 | 6 | 0 | 3 | 3 | 0 | 0 | 0 | 0 | 0 | 0 | 0 | 0 | 0 |
| Surfactant 2 | 6 | 6 | 6 | 3 | 3 | 6 | 6 | 0 | 0 | 0 | 0 | 0 | 0 | 0 |
| Surfactant 1 | 0 | 0 | 0 | 0 | 0 | 0 | 0 | 10 | 15 | 15 | 10 | 10 | 10 | 0 |
| Polyphosphinoacrylic acid/ | 0 | 0 | 0 | 24 | 0 | 0 | 0 | 0 | 0 | 0 | 0 | 0 | 0 | 0 |
| Surfactant 3 (12.5%)/ | | | | | | | | | | | | | | |
| Surfactant 2 (12.5%) (25% | | | | | | | | | | | | | | |
| surfactant) | | | | | | | | | | | | | | |
| Polyphosphinoacrylic acid | 0 | 0 | 0 | 0 | 0 | 24 | 0 | 0 | 0 | 0 | 0 | 0 | 0 | 0 |
| (80%)/Surfactant 3 (20%) | | | | | | | | | | | | | | |
| Polyphosphinoacrylic acid | 0 | 0 | 0 | 0 | 0 | 0 | 24 | 0 | 0 | 0 | 0 | 0 | 0 | 0 |
| (80%)/Surfactant 3 (20%) | | | | | | | | | | | | | | |
| Polyphosphinoacrylic acid | 0 | 0 | 0 | 0 | 0 | 0 | 0 | 25 | 0 | 0 | 0 | 0 | 0 | 0 |
| (80%)/Surfactant 1 (20%) | | | | | | | | | | | | | | |
| Polyphosphinoacrylic acid | 0 | 0 | 0 | 0 | 0 | 0 | 0 | 0 | 0 | 0 | 25 | 0 | 0 | 0 |
| (82.8%)/Surfactant 1 | | | | | | | | | | | | | | |
| (17.2%) | | | | | | | | | | | | | | |
| Polyphosphinoacrylic acid | 0 | 0 | 0 | 0 | 0 | 0 | 0 | 0 | 0 | 0 | 0 | 25 | 0 | 0 |
| (82.8%)/Surfactant 1 | | | | | | | | | | | | | | |
| (17.2%) | | | | | | | | | | | | | | |
| Polyphosphinoacrylic acid | 0 | 0 | 0 | 0 | 0 | 0 | 0 | 0 | 0 | 0 | 0 | 0 | 30 | 0 |
| (50%)/Surfactant 1 (50%) | | | | | | | | | | | | | | |
| Polyphosphinoacrylic acid | 0 | 0 | 0 | 0 | 0 | 0 | 0 | 0 | 0 | 0 | 0 | 0 | 0 | 30 |
| (50%)/Surfactant 1 (50%) | | | | | | | | | | | | | | |
| Poly acrylic Acid | 0 | 6 | 0 | 0 | 0 | 0 | 0 | 0 | 0 | 15 | 0 | 0 | 0 | 0 |
| additional ingredients | 13 | 13 | 37 | 13 | 37 | 13 | 13 | 0 | 0 | 0 | 0 | 0 | 0 | 0 |
| Total | 100 | 100 | 100 | 100 | 100 | 100 | 100 | 100 | 100 | 100 | 100 | 100 | 100 | 100 |

50 Cycle Redeposition Evaluation. 6 Glasses were placed in a rack in a diagonal line along with one plastic glass. The machine was charged with 0.15% (1500 ppm) detergent and the desired volume (mls) for each individual rinse aid. The detergent remained constant for each rinse aid evaluated using a commercially-available Apex Power (Ecolab Inc). A concentration of 0.4% (4000 ppm) food soil was added to the machine (accounting for volume of sump). When the test started the detergent and rinse aid dispensers automatically dosed the proper amount each cycle. The detergent was controlled by conductivity and the rinse aid was dispensed in milliliters per rack. The food soil was hand dosed for each cycle to maintain 0.4% (4000 ppm) concentration. When the test was finished the glasses are allowed to dry overnight and evaluated for film accumulation. Glasses were then stained with Coomassie blue to determine protein residue.

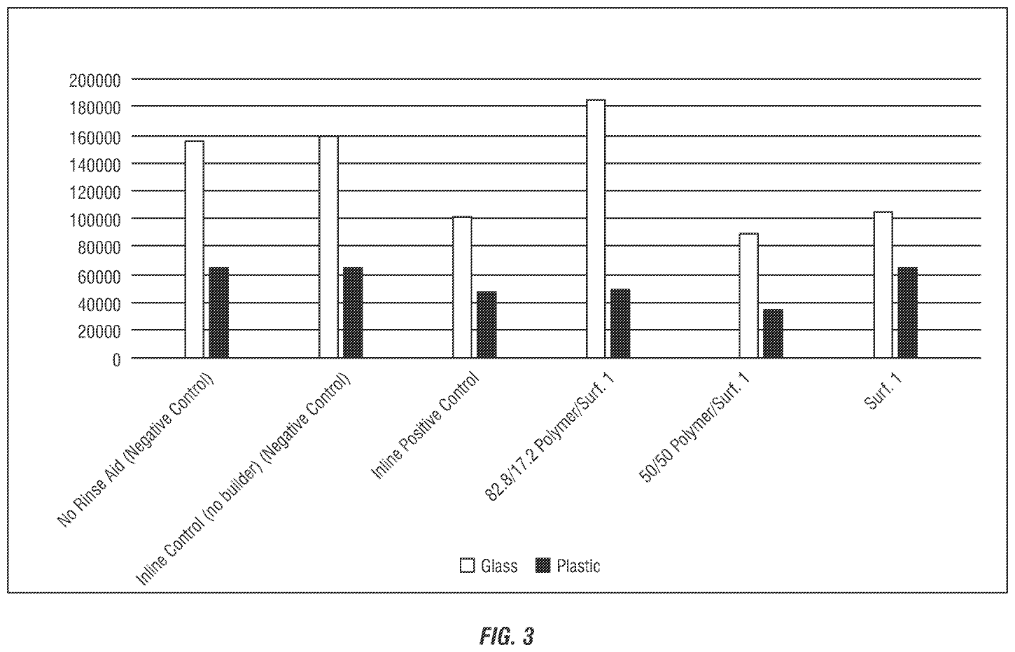

The results are shown in FIG. 3. The graph shows that Polyphosphinoacrylic acid (82.8%)/Surfactant 1 (17.2%) copolymer is slightly better than the inline on Plastic but not as good on the glass for redeposition. The Polyphosphinoacrylic acid/Surfactant 1 (50/50) was better on both glass and plastic. The Polyphosphinoacrylic acid/Surfactant 1 (50/50) was also evaluated under the same conditions with additional surfactant added to the formulation. Polyphosphinoacrylic acid/Surfactant 1 (50/50) showed a slight improvement with additional surfactant to the inline compared to the two samples that were made with no residual. Overall in analyzing performance based on the sheeting, foam and 50 cycle redeposition the most preferred on the solid polymer surfactants is the one with lowest foam, best wetting and redeposition, which as shown in Examples 1-3 are the Polyphosphinoacrylic acid/Surfactant 1 (50/50) copolymers.

### Example 5

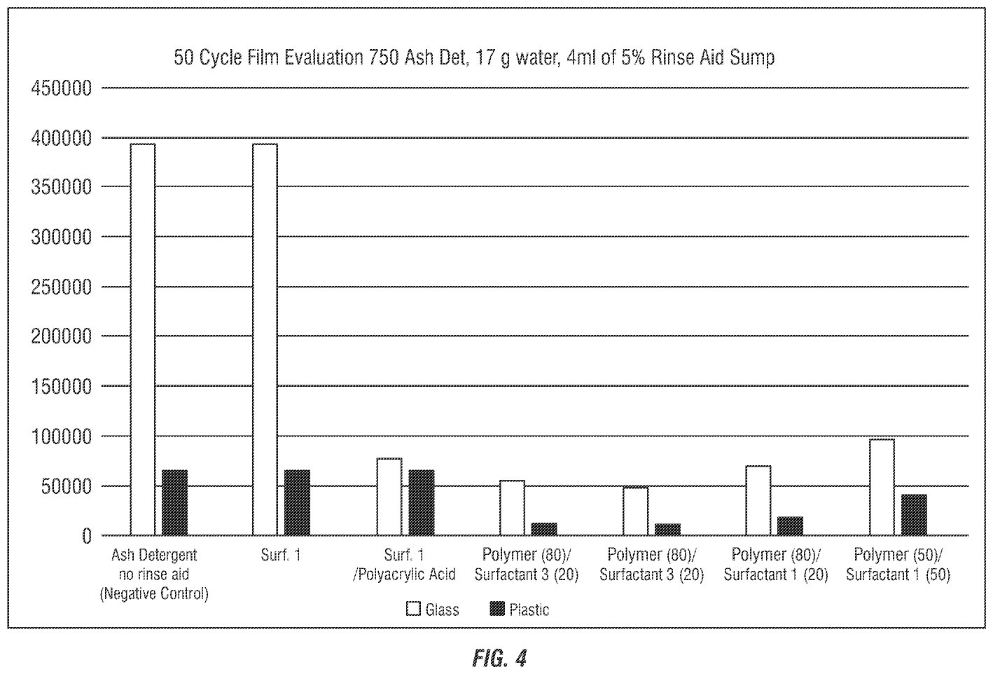

Additional 50 cycle film evaluations were performed according to the methods of Example 4 with a very basic detergent composition to stress the test the most to see differences between solid polymer surfactant compositions. The controls in this evaluation are detergent alone and then the individual raw materials added versus the raw materials added as a solid compound to the formulation. The results are shown in FIG. 4. Overall the solid polymer surfactants performed better on inorganic film then the individual raw material added to the formulation. There is less inorganic film formation with the solid polymer surfactants then the raw materials added in their natural state.

### Example 6

100 cycle film evaluation was conducted according to the following methods. 6 Glasses are placed in a rack in a diagonal line along with one plastic glass. The machine is charged with 0.075% detergent and the desired mls for each individual rinse aid. The detergent stays the same for each rinse aid evaluated. No food soil is added to the machine. When the test starts the detergent and rinse aid dispensers automatically dose the proper amount each cycle. The detergent is controlled by conductivity and the rinse aid is dispensed in milliliters per rack. When the test is finished the glasses are allowed to dry overnight and evaluated for film accumulation. Glasses are then stained with Coomassie blue to determine protein residue

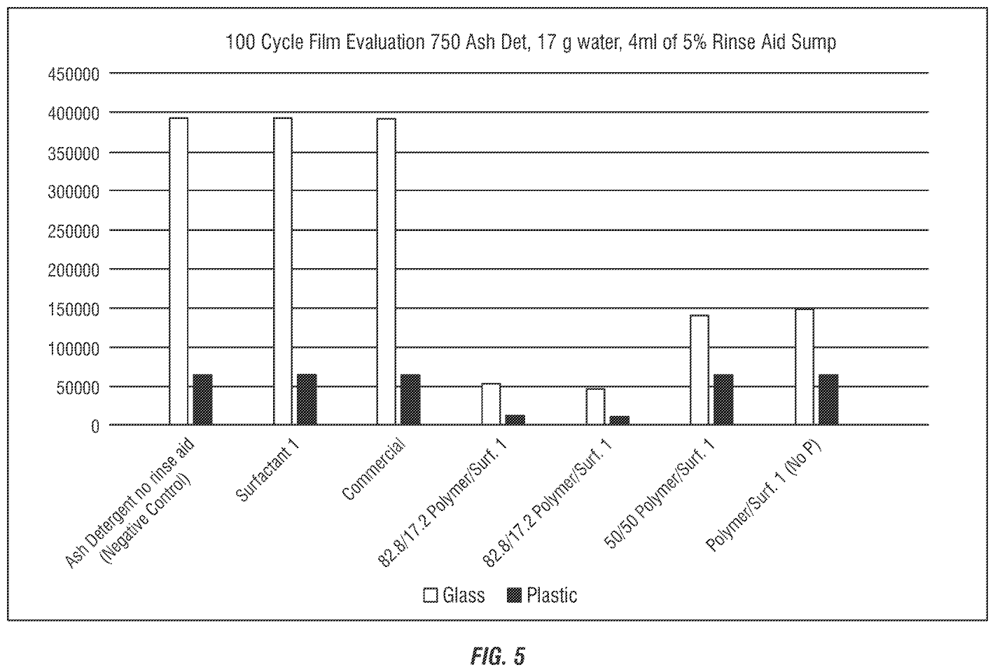

Results from the 100 cycle film evaluation are shown in FIG. 5 and demonstrate that the solid polymer surfactants have less inorganic film formation then the formulations with the individual raw materials added in their normal state. The most preferred of these compounds are the solids using the nonionic defoamer (Surfactant 1) at 50% of the solid then the ones using lower levels of the Surfactant 1. Taking all of the evaluations into consideration all showed excellent sheeting and wetting, the preferred solid polymer surfactants include Polyphosphinoacrylic acid/Surfactant 1 (80/20), Polyphosphinoacrylic acid/Surfactant 1 (50/50), and the no phosphate Polyphosphinoacrylic acid/Surfactant 1 solid copolymer surfactants when looking at the sheeting, wetting and defoaming. These solid polymer surfactant compositions also showed lower redeposition on the 50 cycles then the controls and little to no inorganic film formation on the 50 and 100 cycle film evaluations.

### Example 7

Dynamic Contact Angle Measurement. The test quantitatively measured the angle at which a drop of solution contacts a test substrate. The surfactant(s) and solid copolymer surfactants of desired concentration of 60 ppm surfactant concentration were placed into the apparatus. Rectangles of each plastic substrate material (melamine, polycarbonate, polypropylene) were cut from 6″×6″ square slates. All experiments were carried out on a KRUSS DSA 100 drop shape analyzer. The solution and the coupon are then heated up in the chamber to the desired temperature. For each experiment, the rectangular substrate was placed onto the KRUSS DSA 100 stage with the temperature controlled by a Peltier plate. The temperature was set to 80° C.

The substrate was allowed to rest on the stage for 10 minutes to allow it to reach the desired temperature. A 5 ul droplet of the surfactant solution at 60 ppm surfactant concentration was deposited onto the substrate materials (polypropylene coupon (PP), polycarbonate coupon (PC) and a melamine coupon), and the contact angle between the droplet and the surface was measured over a period of 12 seconds. Three measurements were carried out and averaged for each substrate/surfactant solution combination as shown in Table 18.

The deliverance of the drop to the substrate was recorded by a camera. The video captured by the camera is sent to a computer were the contact angle can be determined. The lower the contact angle the better the solution will induce sheeting. This means that the dishware will dry more quickly and with fewer spots once it has been removed from the dish machine.

TABLE 18

| | | Contact | | Contact | | Contact |
|---|---|---|---|---|---|---|
| | | Angle (deg) | | Angle (deg) | | Angle (deg) |
| | time (s) | Melamine | time (s) | PC | time (s) | PP |
| Surfactant 4 | 9.06 | 37.33 | 9.07 | 57.18 | 9.06 | 71.52 |
| Surfactant 3 | 9.05 | 33.22 | 9.05 | 43.09 | 9.05 | 48.01 |
| Polyphosphinoacrylic | 9.05 | 36.67 | 9.05 | 45.17 | 9.05 | 47.90 |
| acid/Surfactant 3 | | | | | | |
| Surfactant 3/ | 9.0 | 34.0 | 9.0 | 40.3 | 9.1 | 47.9 |
| Surfactant 2 | | | | | | |
| Polyphosphinoacrylic | 9.0 | 29.1 | 9.0 | 46.8 | 9.0 | 54.7 |
| acid/Surfactant 3/ | | | | | | |
| Surfactant 2 | | | | | | |
| Surfactant 1 | 9.1 | 39.0 | 9.0 | 53.7 | 9.0 | 56.1 |
| Polyphosphinoacrylic | 9.0 | 47.2 | 9.0 | 48.0 | 9.0 | 52.3 |
| acid/Surfactant 1 | | | | | | |
| pH as is | | | | | | |

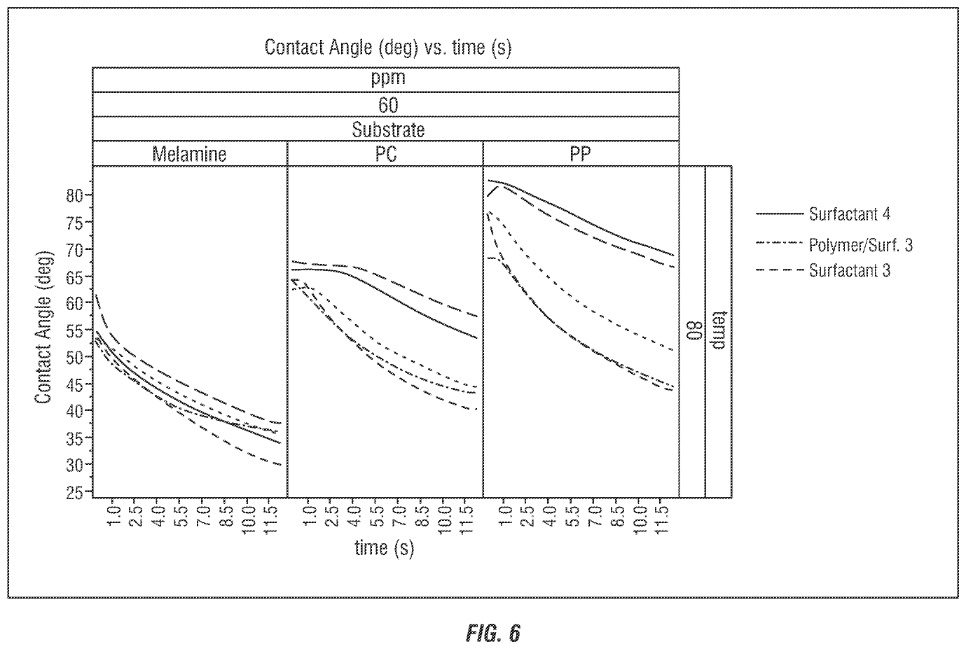

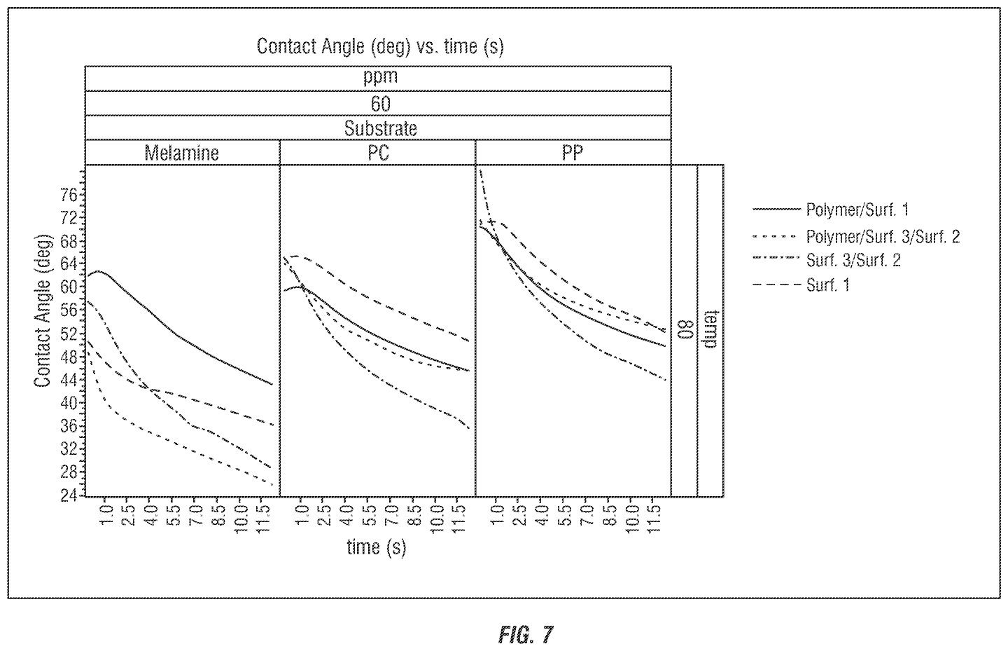

The results showing contact angle measurement are shown in FIG. 6 and FIG. 7 with various surfactants compared to the solid polymer surfactants. The dynamic contact angle correlates with sheeting of the surface. The results show that the dynamic contact angle is driven by the surfactant(s) and that the sheeting results are driven by both the surfactant(s) and polymer solidified into the copolymer.

### Example 8

Additional testing on the impact of molecular weight of the polymer components of the solid polymer surfactants on calcium carbonate scale inhibition was conducted. The following test conditions were employed:

Machine: Apex HT machine (3.67 L rinse & 32 L sump)

Wash temp: 160° F.

Rinse temp: 180° F.

Detergent: 1000 ppm sodium carbonate block (75% sodium carbonate & 25% water) which provided 750 ppm sodium carbonate at use (no builder)

Cycles run: 50 cycles

Polymer concentration: 1.5 ppm active polymer solution was dosed during rinse through the rinse arm.

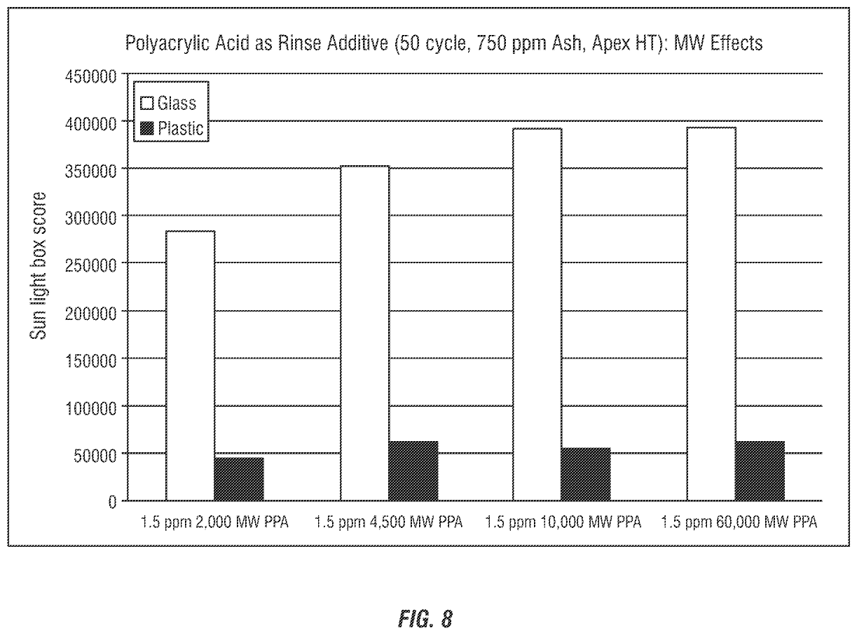

The results are shown in FIG. 8 demonstrating that low MW polyacrylates (PAA) perform better than their higher MW counterparts when incorporated into the rinse. The results show that the low MW polyacrylates having a molecular weight less than 10,000, preferably less than 6,000, and most preferably less than 3,000 achieve the desired performance, defoaming, sheeting, wetting and dry time for the rinse aid application.

The inventions being thus described, it will be obvious that the same may be varied in many ways. Such variations are not to be regarded as a departure from the spirit and scope of the inventions and all such modifications are intended to be included within the scope of the following claims. The above specification provides a description of the manufacture and use of the disclosed compositions and methods. Since many embodiments can be made without departing from the spirit and scope of the invention, the invention resides in the claims.

1-10. (canceled)

11. A solid cleaning and/or rinse aid composition comprising:
(1) a solid copolymer surfactant comprising:
(i) at least one polymer P1) that comprises polymerized units of at least one monomer A) selected from the group consisting of α,β-ethylenically unsaturated carboxylic acids, salts of α,β-ethylenically unsaturated carboxylic acids, α,β-ethylenically unsaturated carboxylic acid anhydrides and mixtures thereof; and
(ii) at least one nonionic surfactant of the general formula (I),
R₁-(A)ₓ(B)_{y1}-(A)_{z}-(B)_{y2}—R₂ (I),
wherein
R₁ and R₂ independently denote H or linear or branched, substituted or unsubstituted C1-C22 alkyl,
A denotes CH₂—CH₂—O,
B denotes CH₂—CHR₃—O, wherein R₃ denotes H or linear or branched, unsubstituted C1-C10 alkyl,
x is an integer in the range from 0 to 35,
y₁ is an integer in the range from 0 to 60,
y₂ is an integer in the range from 0 to 35, and
z is an integer in the range from 0 to 35,
wherein the sum of x+y₁+z+y₂ is at least 1,
wherein the solid copolymer surfactant has a glass transition temperature (Tg) of at least 50° C. as determined by differential scanning calorimetry according to DIN EN ISO 11357-2, at a heating rate of 20 K/min; and
(2) at least one additional surfactant, polymer surfactant, and/or at least one additional functional ingredient.

12. The solid composition of claim 11, wherein (i) the at least one polymer P1) is selected from the group consisting of homopolymers of acrylic acid and copolymers of acrylic acid and sodium phosphinate and has a molecular weight from between about 1,000 to 10,000 g/mole; and (ii) the at least one nonionic surfactant of formula (I) is R₁-(A)ₓ-(B)_{y1}-(A)_{z}-(B)_{y2}—R₂ (I), wherein R₁ and R₂ independently denote H or linear or branched, substituted or unsubstituted C1-C22 alkyl, A denotes CH₂—CH₂—O, B denotes CH₂—CHR₃—O, wherein R₃ denotes H or linear or branched, unsubstituted C1-C10 alkyl, x is an integer in the range from 0 to 35, y₁ is an integer in the range from 0 to 60, y₂ is an integer in the range from 0 to 35, and z is an integer in the range from 0 to 35, and wherein the sum of x+y₁+z+y₂ is at least 1.

13. The solid composition of claim 11, wherein the additional surfactant and/or polymer comprises:
a nonionic alcohol alkoxylate according to the following formula:
R¹—O-(EO)ₓ₃(PO)_{y3}—H (A)
wherein R¹ is a straight-chain C₁₀-C₁₆ alkyl, wherein x3 is from 5 to 8, and wherein y₃ is from 2 to 5;
a nonionic alcohol alkoxylate according to the following formula:
R¹—O-(EO)ₓ₄(PO)_{y4}—H (A2)
wherein R¹ is a straight-chain C₁₀-C₁₆ alkyl, wherein x₄ is from 4 to 6, and wherein y₄ is from 3 to 5;
a nonionic alcohol alkoxylate according to the following formula:
R²—O-(EO)ₓ₁—H (B)
wherein R² is C₁₀-C₁₄ alkyl with an average of at least 2 branches per residue, and wherein x₁ is from 5 to 10;
a nonionic alcohol alkoxylate according to the following formula:
R²—O-(EO)ₓ₂—H (C)
wherein R² is C₁₀-C₁₄ alkyl with an average of at least 2 branches per residue, and wherein x₂ is from 2 to 4;
a surfactant polymer according to the following formula:
R⁷—O—(PO)y₅(EO)x₅(PO)y₆ (D)
wherein R⁷ is a branched C₈-C₁₆ Guerbet alcohol, x₅ is from 5 to 30, y₅ is from 1 to 4, and y₆ is from 10 to 20;
a surfactant polymer according to the following formula:
R⁶—O—(PO)y₄(EO)x₄ (E)
wherein R⁶ is a C₈-C₁₆ Guerbet alcohol, wherein x₄ is from 2 to 10, and wherein y₄ is from 1 to 2;
a surfactant polymer according to the following formula: 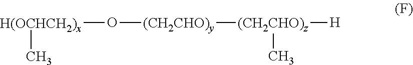
wherein x is from 120-220, y is from 12 to 20, and z is from 12 to 20;
a surfactant polymer according to the following formula: 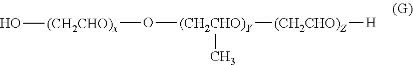
wherein x is from 88 to 108, y is from 57 to 77, and z is from 88 to 108;
a surfactant polymer according to the following formula: 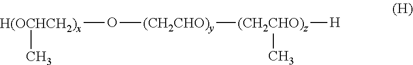
wherein x is from 15 to 25, y is from 10 to 25, and z is from 15 to 25;
a surfactant polymer according to the following formula:
R⁴—O-(EO)ₓ(XO)_{y}—H (I)
wherein R₄ is C₁₃-C₁₅ alkyl, x is from 8 to 10, y is from 1 to 3, and XO is butylene oxide;
a surfactant polymer according to the following formula:
R⁵—O-(EO)ₓ(PO)_{y}—H (J)
wherein R₅ is C₁₂-C₁₅ alkyl, x is from 3 to 5, and y is from 5 to 7;
or combinations thereof.

14. The solid composition of claim 11, wherein the at least one additional functional ingredient comprises a hardening agent, carrier, chelating agent, sequestering agent, builder, water conditioner, bleaching agent, sanitizer, defoaming agent, anti-redeposition agent, optical brightener, dye, odorant, stabilizing agent, dispersant, enzyme, corrosion inhibitor, additional surfactant, thickener and/or solubility modifier.

15. The solid composition of claim 11, wherein the composition comprises from about 50 wt-% to about 90 wt-% of the solid copolymer surfactant, from about 1 wt-% to about 50 wt-% of the additional surfactant and/or polymer, and from about 1 wt-% to about 90 wt-% of the additional functional ingredient.

16. The solid composition of claim 11, wherein the composition is a pressed solid, extruded solid or cast solid.

17. The solid composition of claim 11, wherein the total surfactant concentration is at least about 15 wt-%, at least about 35 wt %, or at least about 50 wt %.

18. The solid composition of claim 11, wherein the composition provides a use solution comprising less than about 125 ppm active surfactant concentration.

19. The solid composition of claim 11, where the composition is substantially-phosphate free containing less than about 0.5 wt-% phosphate, preferably the composition is phosphate free.

20-26. (canceled)

27. A method for cleaning and/or rinsing a surface comprising:
providing a solid composition according to claim 11;
contacting the solid composition with water to form a use solution; and
applying the use solution to a surface in need of cleaning and/or rinsing, wherein the use solution provides from about 1 ppm to about 125 ppm active surfactant concentration.

28. The method of claim 27, further comprising the step of reducing the contact angle of the surfactant system composition by at least about 5° compared to the contact angle of a commercially-available rinse aid composition to induce sheeting and result in a faster drying time of the surface.

29. The method of claim 27, wherein the use solution is substantially-phosphate free containing less than about 0.5 wt-% phosphate.

30. The method of claim 27, wherein the surface in need of cleaning and/or rinsing is a ware wash substrate, laundry substrate and/or hard surface.

31. A method of dispensing a solid cleaning and/or rinse aid composition comprising:
providing the solid composition according to claim 11;
generating a use solution by contacting with an aqueous source; and
dispensing the use solution to an application of use in need of a cleaning and/or rinse aid composition.

32. The method of claim 31, wherein use solution comprises less than about 125 ppm active surfactant concentration.

33. The method of claim 31, wherein the dispensing is from either an integrated or stand-alone solid product dispenser, wherein the use solution flows out of the dispenser.

34. The method of claim 31, wherein the dispensing comprises direct placement of the solid cleaning and/or rinse aid composition into a vessel or apparatus without the use of a dispenser to generate the use solution.

35. The method of claim 31, where the use solution is dispensed to a ware wash application, laundry application and/or hard surface application.
